(19) United States
(12) Patent Application Publication
(10) Pub. No.: US 2025/0185078 A1
(43) Pub. Date: Jun. 5, 2025

(54) SYSTEMS, METHODS, AND DEVICES FOR SIGNALING AND PROCEDURE FOR COMMUNICATION TO UL-ONLY TRP

(71) Applicant: Apple Inc., Cupertino, CA (US)

(72) Inventors: Seyed Ali Akbar FAKOORIAN, San Diego, CA (US); Dawei ZHANG, Saratoga, CA (US); Haitong SUN, Saratoga, CA (US); Wei ZENG, Saratoga, CA (US); Hong HE, San Jose, CA (US)

(21) Appl. No.: 18/963,217

(22) Filed: Nov. 27, 2024

Related U.S. Application Data
(60) Provisional application No. 63/604,758, filed on Nov. 30, 2023.

(51) Int. Cl. H04W 74/0838; H04B 7/06; H04B 17/318

(52) U.S. Cl. CPC H04W 74/0838; H04B 7/06952; H04B 17/328

(57) ABSTRACT

Solutions are provided for signaling and procedure for enabling uplink (UL) communications toward a base station operating as a UL-only transmission and reception point (TRP). One or more of these solutions may apply to contention-based random access (CBRA) procedures. One or more other solutions are provided for contention free random access (CFRA) procedures. Also provided are solutions for determining appropriate timing advanced (TA) signals for UEs communicating for a UL-only TRP. Also provided are transmission power control solutions for UL transmission via a physical random access (RA) channel (PRACH), a physical UL shared channel (PUSCH), and a PUCH, in addition to transmission power control solutions for sounding reference signal (SRS) transmissions.

### CROSS-REFERENCES TO RELATED APPLICATIONS

This application claims the benefit of U.S. Provisional Application No. 63/604,758, filed Nov. 30, 2023, the entire disclosure of which is herein incorporated by reference for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview according to one or more implementations described herein.

FIG. 2 is a diagram of an example network according to one or more implementations described herein.

FIG. 3 is a diagram of an example of a master cell group (MCG) and a secondary cell group (SCG) according to one or more implementations described herein.

FIGS. 4-7 are diagrams of examples of random access (RA) procedures that may be enhanced by one or more of the techniques described herein.

FIG. 8 is a diagram of an example of a process for determining whether to configure a user equipment (UE) for a uplink (UL) only transmission and reception point (TRP) according to one or more implementations described herein.

FIG. 9 is an example of information that may be included in a type 1 system information block (SIB1) according to one or more implementations described herein.

FIGS. 10-11 are diagrams of examples of RA channel (RACH) occasions (ROs) associated with different synchronization signal blocks (SSBs) according to one or more implementations described herein.

FIG. 12 is a diagram of an example for implementing a UL-only operation together with a main TRP operation according to one or more implementations described herein.

FIG. 13 is a diagram of an example of a process for transitioning between UL communications toward a main TRP and a UL-only TRP according to one or more implementations described herein.

FIG. 14 is a diagram of an example of a process for transitioning between UL communications toward a main TRP and a UL-only TRP according to one or more implementations described herein.

FIG. 15 is a diagram of an example for providing an effective timing advance (TA) for a UL-only TRP according to one or more implementations described herein.

FIG. 16 is a diagram of an example of a process for transmission power control based on path loss (PL) according to one or more implementations described herein.

FIG. 17 is a diagram of an example of a process for transmission power control for physical uplink shared channel (PUSCH) transmissions during a physical random access channel (PRACH) procedure according to one or more implementations described herein.

FIGS. 18-20 are diagrams of examples of processes for signaling and procedure for communication to UL-only TRP according to one or more implementations described herein.

FIG. 21 is a diagram of an example of components of a device according to one or more implementations described herein.

FIG. 22 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include a UE providing base stations with capability information, the network determining how to configure the UE based on the capability information, the network providing the UE with configuration information, and the UE and base station communicating further in accordance with the configuration information.

Transmissions from a base station to a UE may be referred to as a downlink (DL) communication. Transmissions from a UE to a base station may be referred to as an uplink (UL) communication. In some implementations, UL communications may be bottleneck or limiting factor relative to DL communications. As such, UL communications may include protocols for transmission repetitions, supplemental uplink (SUL), heterogeneous networks (HetNets), and other network enhancements to address the demand for UL communications. Adding a regular transmission-reception point (TRP) in a vicinity of a main TRP may improve UL coverage for a UE at or near a cell edge (e.g., at or near a maximum coverage distance of the main TRP). A main TRP may include a base station or macro cell. A regular TRP may include a relay point, network-controlled repeater (NCR), or a small cell operating as an intermediate between a UE and the main TRP. However, while introducing a regular TRP may improve UL communications, doing so may increase interference with DL communications from the main TRP. As such, a regular TRP may be configured to operate as a UL-only TRP, meaning the TRP may receive UL communications but not send DL communications. A UL-only TRP may also be referred to as an reception (RX) only (RX-only) TRP.

In a UL-only scenario, DL communications may be from the main TRP to the UE and UL communications will be from the UE to a UL-only TRP. Such an arrangement may provide several benefits for UEs at or near a coverage edge of the main TRP. Examples of such benefits may include: 1) no or minimal DL interference relative to scenarios involving a regular TRP supporting both a DL and UL communications; 2) a reduction in UL transmission power consumption and UL interference relative to UL transmissions that may otherwise be directed to the main TRP; 3) improved UL resource utilization given specially separated UEs may be served via the same physical resource block (PRBs); and 4) UL communications may be performed using a single frequency instead of multiple frequencies (like with SUL).

Despite such benefits, currently available techniques fail to provide any, or adequate, solutions, since the UE has different communication points (e.g., the main TRP for DL communications and a regular TRP for UL communications). In typical scenarios (e.g., where UL communications and DL communications have the same TRP), characteristics or parameters of UL communications and DL communications may be determined based on, or relative to, one another. Examples of such parameters may include: 1) a timing advance (TA) parameter applied to UL communications may be based on a DL communication reception time; 2) UL transmission power being determined based on a path-loss of DL communications; 3) UL beam management being based on a status and characteristics of a corresponding UL beam. As such, while configuring a UE to only communicate UL traffic to a regular TRP and only receive DL traffic from a main TRP may include certain benefits, currently available technologies fail to provide solutions to enable such a configuration to operate.

One or more of the techniques described herein provide solutions that address the deficiencies of the currently available technology. For example, various solutions are provided for configuring a UE to communicate with a UL-only TRP operating in coordination with a main TRP. Also provided are solutions for determining proper TA for UL communications, controlling UL transmission power, and managing beams for UL communications between a UE and UL-only TRP. The techniques described herein may also include enabling a UE to transition from UL communications involving a main TRP to UL communications involving a UL-only TRP. Details and examples of these and other techniques are described herein with reference to the figures discussed below.

As described herein, a TRP may refer to a base station or another type of network node. A main TRP may refer to a base station operating as master cell or primary cell (PCell) with respect to a particular UE. A regular TRP may refer to a base station that is operating as a secondary cell (SCell), relative to a PCell, and that is configured to communicate with a UE via DL and UL communications. A UL-only TRP may include a base station operating as an SCell, relative to a PCell, and that is configured to only communicate to a UE via UL communications. A macro cell may include a cell that involves the combined coverage area and capabilities of multiple coordinated base stations (e.g., a PCell and multiple SCells). A main TRP may include a main TRP as referred to herein. In some scenarios, a TRP may operate as a regular TRP (sending and receiving DL and UL communications) with respect to certain UEs while operating as a UL-only TRP with respect to other UEs.

As described herein, references to a random access (RA) procedure, a RACH procedure, and/or a PRACH procedure may each refer to the same type of procedure. Additionally, or alternatively, references herein to a RA procedure (and the like) may refer to a 4-step RA procedure, a 2-step RA procedure, a contention-based RA procedure, or a contention-free RA procedure. Furthermore, references to a RA procedure may refer to a RA procedure toward a main TRP and/or a RA procedure toward a UL-only TRP.

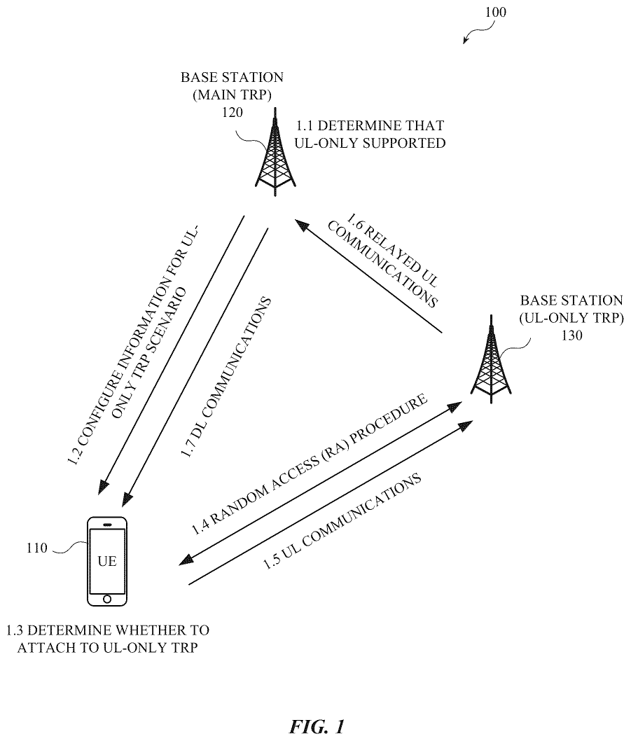

FIG. 1 is a diagram of an example of an overview 100 according to one or more implementations described herein. As shown, overview 100 may include UE 110, base station 120, and base station 130. Base station 120 may be operating as a main TRP. Base station 130 may be capable of operating as a UL-only TRP.

Base station 120 may be configured to determine whether a UL-only configuration is supported by UE 110, base station 120, and/or base station 130 (at 1.1). In response to UL-only being supported, base station 120 may provide UE 110 with configuration information for implementing a UL-only scenario (at 1.2). A UL-only scenario may include an arrangement where a main TRP provides DL communications to UE 110 but receives UL communication from UE 110 via a UL-only TRP. The configuration information may include direct instructions for UE 110 to implement a UL-only scenario, conditions for implementing a UL-only scenario, etc.

Based on the configuration information, UE 110 may determine whether attach to base station 130 as a UL-only TRP (at 1.3). For example, UE 110 may determine to attach to a UL-only TRP when a measure signal strength from base station 120 drops below a threshold strength. In another example, UE 110 may determine that the configuration information includes explicit or implicit instructions for UE to attach to a UL-only TRP. UE 110 may perform a random access (RA) procedure toward base station 130 (at 1.4). The RA procedure may include a 4-step RA procedure or a 2-step RA procedure. Additionally, or alternatively, the RA procedure may include a contention-based RA (CBRA) procedure or a contention free RA (CFRA) procedure.

Upon completing the RA procedure, base station 130 may operate as a UL-only TRP for UE 110. For UL communications intended for base station 120, UE 110 may send the UL communications to base station 130 (at 1.5), and base station 130 may relay the UL communications to base station 120 (at 1.6). DL communications from base station 120 may be sent directly to UE 110 (at 1.7). As such, one or more of the techniques described herein enable UE 110, base station 120, and base station 130 to configure and operate in a UL-only TRP scenario. These and other features are described in detail below with reference to the Figures that follow.

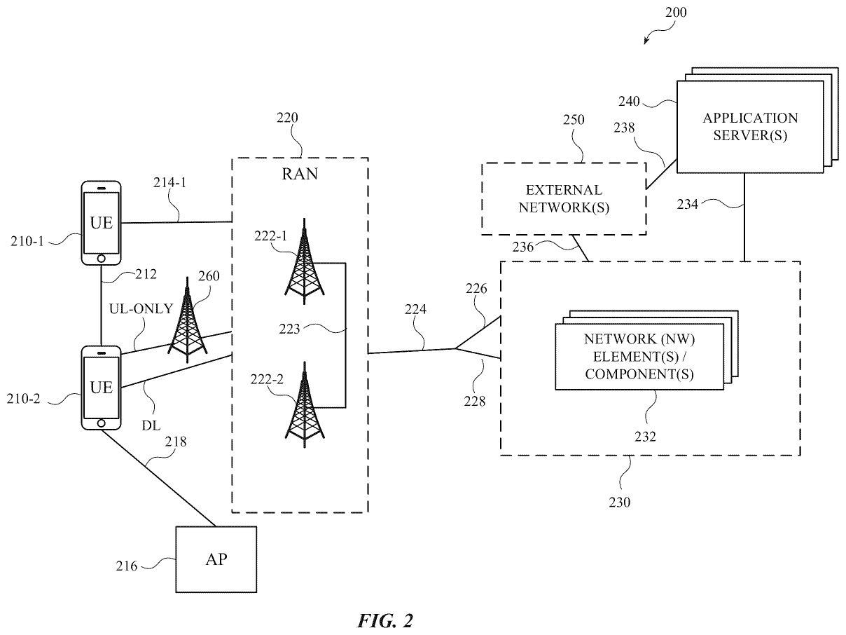

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222. In some scenarios, RAN 120 can coordinate with core network 130 via interfaces 124, 126, and/or 128.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

One or more of the techniques described herein may include TRP 260. TRP 260 may include a base station (or another type of network access node or repeater) capable of operating as a regular TRP and/or as a UL-only TRP. When operating in a regular mode, TRP 260 may send and receive DL communications and UL communications between UE 210 and the network. When operating in a UL-only mode, TRP 260 may only receive UL communications from UE 210 and relay the UL communications to the network (e.g., to base station 222-1). In such scenarios, TRP 260 may be operating as an SCell and base station 222-1 may be operating as a PCell. One or more of the techniques include solutions for configuring UE 210 to communicate with a UL-only TRP 260 that is operating in coordination with a main TRP (e.g., base station 222-1). Also described are solutions for determining proper TA for UL communications, controlling UL transmission power, and managing beams for UL communications between a UE and UL-only TRP 260. The techniques described herein may also include enabling UE 210 to transition from UL communications involving a main TRP to UL communications involving a UL-only TRP. For example, when UE 210 moves outside of a UL coverage of base station 222-1, UE 210 may transition from UL communications transmitted directly to base station 222-1 to UL communications transmitted via UL-only TRP 260.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

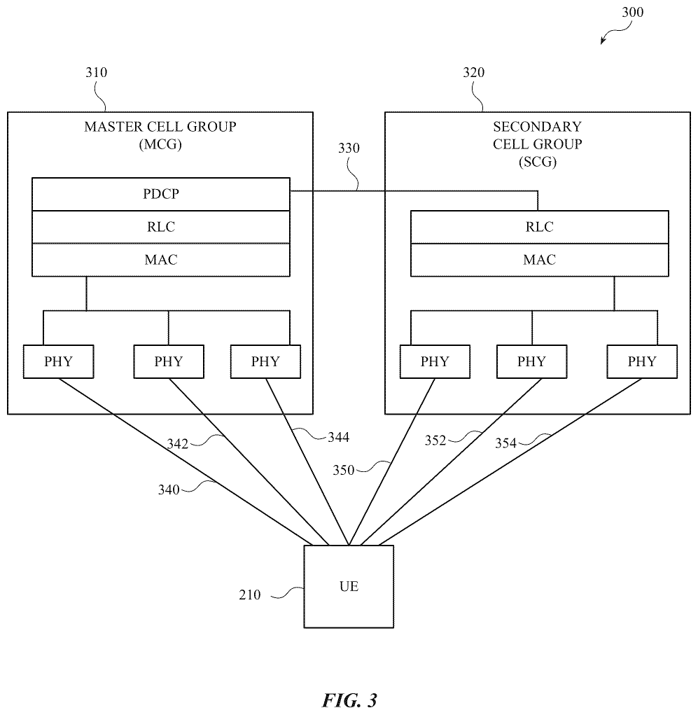

FIG. 3 is a diagram of an example 300 of a master cell group (MCG) 310 and a secondary cell group (SCG) 320 according to one or more implementations described herein. An MCG may include a group of cells associated with a master node, comprising a PCell and one or more SCells. An SCG may include a group of serving cells associated with a secondary node, comprising a primary cell of the secondary cell group (PSCell) and optionally one or more SCells. MCG 310 and SCG 320 may each be implemented by one or more base station 222 and/or another type of RAN node or access point.

MCG 310 may be implemented by one or more base stations and may include one or more layers. Examples of such layers may include a PDCP layer, an RLC layer, a MAC layer, and multiple PHY layers. Each PHY layer may correspond to a different implementation of a cell with respect to UE 210. Additionally, or alternatively, the PHY layers may operate in combination (e.g., be managed, controlled by, etc.) the PDCP, RLC, and MAC layers. In some implementations, one PHY layer 340 may operate as a PCell or a special cell (SpCell) and other PHY layers 342 and 344 may operate as SCells to the PCell.

SCG 320 may include multiple layers as well, including an RLC layer, a MAC layer, and multiple PHY layers 350, 352, and 354. SCG 320 may not include a PDCP layer, but instead may rely on the PDCP layer of MCG 310 via connection 330. Similar to the PHY layers of MCG 310, the PHY layers of SCG 320 may each function or operate as a cell with respect to UE 210. In some implementations, one PHY layer 350 may operate as a primary cell (PCell) to PHY layers 352 and 354, which may operate as secondary cells to the PCell of PHY layer 350. Additionally, MCG 310 and SCG 320 may each include a PCell (e.g., 340 and 350), and a PCell may be referred to herein as a special cell or special primary cell, represented as SpCell. Further, a SCell, of either MCG 310 or SCG 320, may operate as a scheduling secondary cell (sSCell) configured to provide configuration, scheduling, activation, deactivation, and other functions or commands toward a SpCell of either MCG 310 or SCG 320.

MCG 310 and SCG 320 may be involved in a dual connectivity scenario with UE 210, in which case a random access channel (RACH) procedure, and the like, may be directed to MCG 310. MCG 310 and SCG 320 may also implement a standalone (SA) and/or a non-standalone (NSA) network environment for UE 210. In a SA network environment, MCG 310 and SCG 320 may communicate with UE 210 using 5G NR communication standards. In a NSA network environment, MCG 310 and SCG 320 may communicate with UE 210 using a combination of 4G LTE and 5G NR communication standards. MCG 310 and/or SCG 320 may be configured to enable, support, and/or operate in accordance with the techniques described herein for signaling and procedure for communications via a UL-only TRP. For example, one or more of the techniques described herein may include solutions for scenarios in which a macro cell (e.g., a base station 222 operating as a MCG or PCell with respect to UE 210) causes or enables UL-only communications via another base station 222 that is operating as a SCG or SCell.

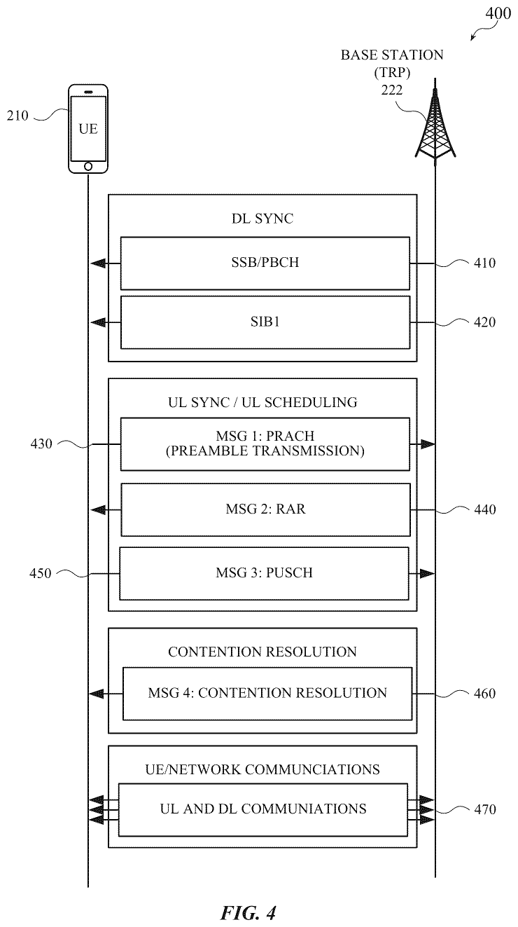

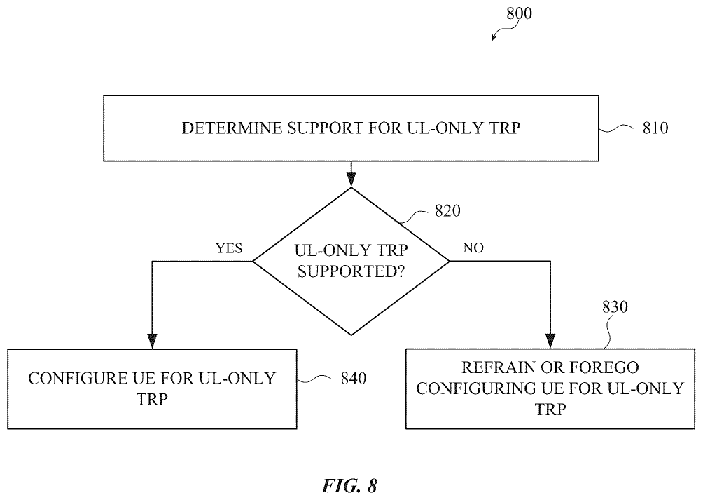

One or more of the techniques described herein may be implemented as an enhancement to one or more aspects of a RA procedure in one or more ways. Examples of such RA procedures may include a 4-step contention-based RA (CBRA) procedure, a 4-step contention-free RA (CFRA) procedure, a 2-step CRBA procedure, and a 2-step CFRA procedure. FIGS. 4-7 are diagrams of examples of RA procedures that may be enhanced by one or more of the techniques described herein. Examples of such enhancements are described further below in FIG. 8 and those that follow.

FIG. 4 is a diagram of an example of a process 400 for a RACH procedure according to one or more implementations described herein. Process 400 may include a 4-step contention-based RA (CBRA) procedure. Generally, a RACH procedure may include a series of operations whereby UE 210 and base station 222 may discover and connect with one another. Process 400 may be implemented by UE 210 and one or more base stations 222. In some implementations, some or all of process 400 may be performed by one or more other systems or devices, including one or more of the devices of FIG. 2. For example, one or more operations of process 400 may pertain to base station 222 operating as a PCell, while one or more other operations of process 400 may pertain to a different base station 222 operating as an SCell relative to the PCell base station. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or processes depicted in FIG. 4.

As shown, process 400 may include UE 210 and base station 222 establishing DL synchronization. This may include UE 210 scanning various frequencies for a synchronization signal periodically broadcasted by base station 222. For example, base station 222 may periodically broadcast a signal (via a physical broadcast channel (PBCH)) that includes a synchronization signal block (SSB) (block 410). The SSB/PBCH may include a primary synchronization signal (PSS), a secondary synchronization signal (SSS), a demodulation reference signal (DMRS) and one or more additional or alternative types of information transmitted via the PBCH (e.g., PBCH data).

This information may enable UE 210 to synchronize and interpret further communications from base station 222. An example of such communications may include the transmission of a signal that includes a system information block (SIB) Type 1 (SIB1) (block 420). An SIB1 may include a variety of one or more types of information configured to enable communications between UE 210 and base station 222, such as a master information block (MIB), SIB1-RRC information, a cell identity group (Cell ID), a tracking area code (TAC), and more. An MIB may include information, such as a system bandwidth, frame structure, and physical layer timing information. The MIB may also contain a physical cell identity (PCI), which may be a unique identifier of base station 222 within a specific geographical area. SIB1-RRC information may include information related to the RRC layer, which may be responsible for managing connections between UEs 210 and base station 222.

SIB1-RRC information may include parameters describing or indicating frequency bands supported by the network, beamforming information, SIB scheduling information, DL control information, and more. A cell ID group may indicate a cell group identity of base station 222, which may be used by UE 210 for cell selection and/or cell reselection. A TAC may include a unique identifier for a tracking area, which may correspond to a geographical area managed by the network. The TAC may enable UE 210 to identify a geographical location and/or network associated with base station 222, which may cause or enable UE 210 to operate in one or more ways, such as a determination of whether to proceed with connecting to a network of base station 222.

As shown, process 400 may include UL synchronization and UL scheduling. For example, UE 210 may communicate a first RACH message (MSG 1) to base station 222 (block 430). MSG 1 may include a preamble transmission, whereby UE 210 may select a random access preamble from a set of predefined preambles. The preamble may be based on, or be consistent with, a short preamble or a long preamble format, and UE 210 may also, or alternatively, select a random sequence number for the preamble. The preamble and/or random sequence number may be used by UE 210 as a signature of the UL transmission from UE 210 to base station 222. After choosing the preamble and sequence number, UE 210 may transmit the preamble to base station 222 via a physical RACH (PRACH).

Base station 22 may receive MSG 1 from UE 212 and may respond by sending UE 210 a random access response (RAR) message (block 440). The RAR message may be referred to as a second message (MSG 2) of the RACH procedure. MSG 2 may include information, such as a TA command for timing adjustment, a random access preamble ID (RAPID) matching the preamble sent by UE 210, and an initial UL grant for UE 210 to continue sending information to base station 222. MSG 2 may also include a temporary identifier of base station 222, which may include a RA radio network temporary identifier (RA-RNTI).

UE 210 may respond to MSG 2 by sending a third message (MSG 4) of the RACH procedure (block 450). UE 210 may do so using the UL grant provided in MSG 2. This may involve UE 210 using a physical UL shared channel (PUSCH). MSG 4 may include one or more types of higher level information, such as a RRC message (e.g., a resource request (RrcRequest message)) and/or include information at the physical layer.

After processing MSG 4, base station 222 may respond by sending a fourth RACH message (e.g., MSG 4) (block 460). MSG 4 may include MAC information for contention resolution. Contention resolution may refer to a scenario in which multiple UEs 210 have requested the same, overlapping, or otherwise interfering resources for communicating with base station 222. The contention resolution message may contain an identity of UE 210, which may confirm that base station 222 has correctly identified UE 210 from among competing UEs 210 and/or indicate that contention has been resolved. Base station 222 may provide UE 210 with a cell radio network temporary identifier (C-RNTI), which UE 210 may use to continue communicating with base station 222 (block 470). Accordingly, UE 210 and base station 222 may perform a RACH procedure to enable UE 210 and base station 222 to identify one another and establish resources for communicating with one another.

In some implementations, base station 222 may be a main TRP that send DL communications to UE 210 directly and receives UL communications from UE 210 via a UL-only TRP (not shown). In some impetrations, base station 222 may be a UL-only TRP that receives UL communications from UE 210 and relays the UL communications to main TRP. Additional examples of these and other features and implementations are described below with reference to the Figures that follow.

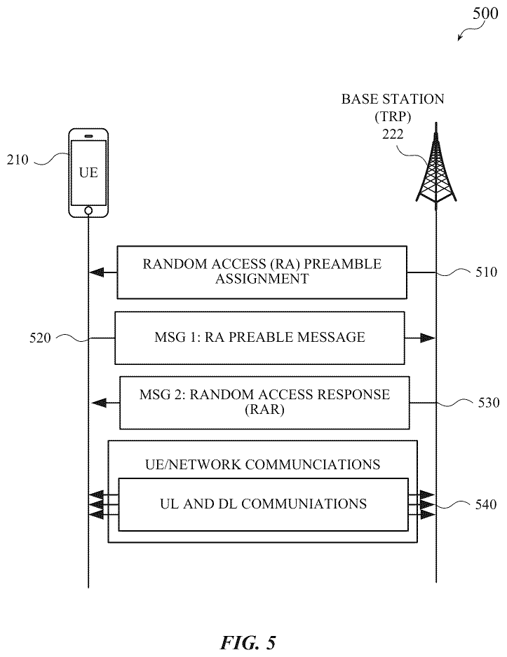

FIG. 5 is a diagram of an example of a process 500 for a RA procedure according to one or more implementations described herein. Process 500 may include a 4-step contention free RA (CFRA) procedure. Generally, a RA procedure may include a series of operations whereby UE 210 and base station 222 may discover and connect with one another. Process 500 may be implemented by UE 210 and one or more base stations 222. In some implementations, some or all of process 500 may be performed by one or more other systems or devices, including one or more of the devices of FIG. 2. For example, one or more operations of process 500 may pertain to base station 222 operating as a PCell, while one or more other operations of process 500 may pertain to a different base station 222 operating as an SCell relative to the PCell base station. Additionally, process 500 may include one or more fewer, additional, differently ordered and/or arranged operations than those shown in FIG. 5. For example, process 500 may include operations for SSB/PBCH and SIB1 transmissions (blocks 410 and/or 420) described above with reference to FIG. 4. In some implementations, some or all of the operations of process 500 may be performed independently, successively, simultaneously, etc., of one or more of the other operations of process 500. As such, the techniques described herein are not limited to a number, sequence, arrangement, timing, etc., of the operations or processes depicted in FIG. 5.

Process 500 may include UE 210 receiving a RA preamble assignment from base station 222 operating as a TRP (at 510). A CFRA procedure may involve base station 222 sending UE 210 an SIB index, PRACH preamble, RACH occasion (RO) and one or more additional types of information. This may be sent by base station 222 as system information. UE 210 may respond with an MSG 1 RA message (at 520). This message may include a RA preamble message. The preamble may enable base station 222 to identify which MSG 1 is being received from which UE 210. Since the RA preamble in process 400 was selected by base station 222, process 400 may be a contention free RA procedure since base station 222 may not receive MSG 1 RA messages with the same preamble.

Base station 222 may receive the MSG 1 RA message and respond with an MSG 2 RA message (also referred to as an RAR message) (at 530). A RAR message may include information, such as a TA command for timing adjustment, a RAPID matching the preamble sent by UE 210, and an initial UL grant for UE 210 to continue sending information to base station 222. A RAR may also include a temporary identifier of base station 222, which may include a RA-RNTI. Upon receiving the RAR message, UE 210 may proceed to communicate with base station 222 via UL communications and DL communications (at 540).

In some implementations, base station 222 may be a main TRP that send DL communications to UE 210 directly and receives UL communications from UE 210 via a UL-only TRP (not shown). In some impetrations, base station 222 may be a UL-only TRP that only receives UL communications from UE 210 and relays the UL communications to a main TRP. Additional example of these and other features and implementations are described below with reference to the Figures that follow.

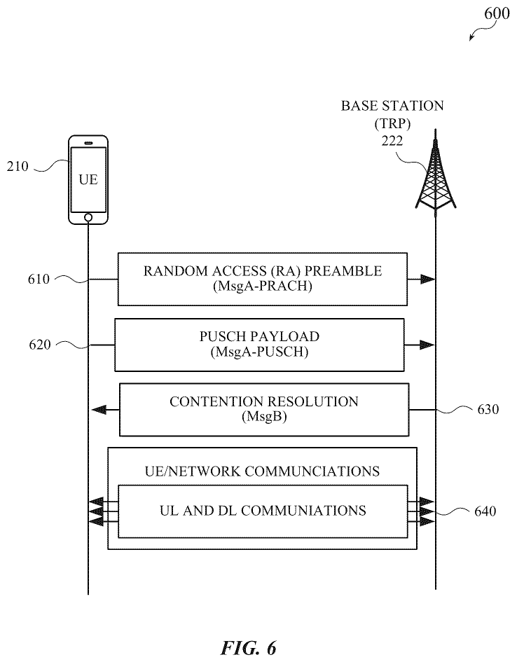

FIG. 6 is a diagram of an example of a process 600 for a RA procedure according to one or more implementations described herein. Process 600 may include a 2-step CBRA procedure. Generally, a RA procedure may include a series of operations whereby UE 210 and base station 222 may discover and connect with one another. Process 600 may be implemented by UE 210 and one or more base stations 222. In some implementations, some or all of process 600 may be performed by one or more other systems or devices, including one or more of the devices of FIG. 2. For example, one or more operations of process 600 may pertain to base station 222 operating as a PCell, while one or more other operations of process 600 may pertain to a different base station 222 operating as an SCell relative to the PCell base station. Additionally, process 600 may include one or more fewer, additional, differently ordered and/or arranged operations than those shown in FIG. 6. For example, process 500 may include operations for SSB/PBCH and SIB1 transmissions (blocks 410 and/or 420) described above with reference to FIG. 4. In some implementations, some or all of the operations of process 600 may be performed independently, successively, simultaneously, etc., of one or more of the other operations of process 600. As such, the techniques described herein are not limited to a number, sequence, arrangement, timing, etc., of the operations or processes depicted in FIG. 6.

As shown, process 600 may include UE 210 sending a RA preamble to base station 222 (at 610). UE 210 may send the RA preamble in a MsgA-PRACH message. UE 210 may select the RA preamble, such that it may be possible that base station 222 may receive MsgA-PRACH messages with the same RA preamble from different UEs 210. Such a scenario may give rise to contention resolution. UE 210 may also send a PUSCH payload to base station 222 (at 620). This may include a MsgA-PRACH message. The MsgA-PRACH message and the MsgA-PRACH message may include information similar to MSG 1 and MSG 3 of a 4-step RACH procedure. Base station 222 may respond with a MsgB message (at 630). The MsgB message may include a RAR message and/or a contention resolution message. A RAR message may include information, such as a TA command for timing adjustment, a RAPID matching the preamble sent by UE 210, and an initial UL grant for UE 210 to continue sending information to base station 222. A RAR may also include a temporary identifier for base station 222, which may include a RA-RNTI. As such, just as a MsgA message may be similar to MSG 1 and MSG 3 of a 4-step RACH procedure, a MsgB message may be similar to a combination of MSG 3 and MSG 4 of a 4-step RACH procedure. Upon receiving the RAR message, UE 210 may proceed to communicate with base station 222 via UL communications and DL communications (at 640).

In some implementations, base station 222 may be a main TRP that send DL communications to UE 210 directly and receives UL communications from UE 210 via a UL-only TRP (not shown). In some impetrations, base station 222 may be a UL-only TRP that only receives UL communications from UE 210 and relays the UL communications to a main TRP. Additional example of these and other features and implementations are described below with reference to the Figures that follow.

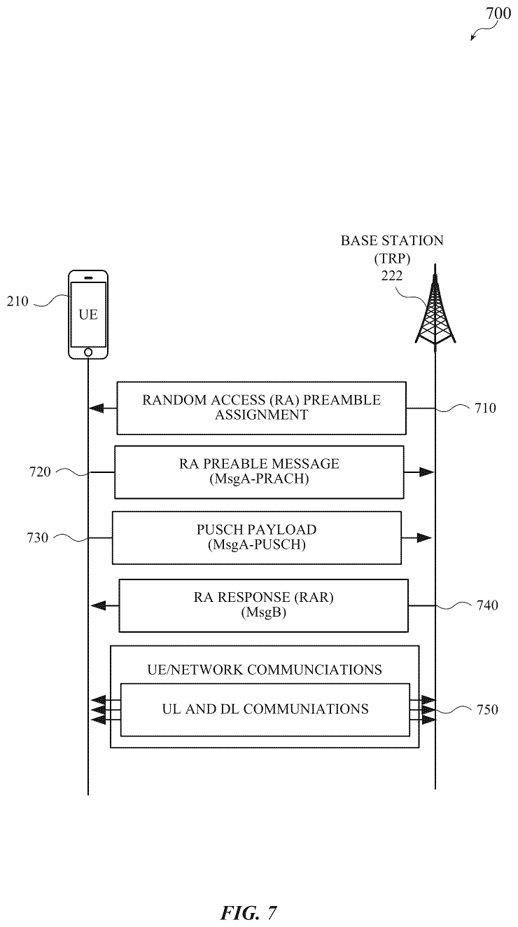

FIG. 7 is a diagram of an example of a process 700 for a RA procedure according to one or more implementations described herein. Process 700 may include a 2-step CFRA procedure. Generally, a RA procedure may include a series of operations whereby UE 210 and base station 222 may discover and connect with one another. Process 700 may be implemented by UE 210 and one or more base stations 222. In some implementations, some or all of process 700 may be performed by one or more other systems or devices, including one or more of the devices of FIG. 2. For example, one or more operations of process 700 may pertain to base station 222 operating as a PCell, while one or more other operations of process 700 may pertain to a different base station 222 operating as an SCell relative to the PCell base station. Additionally, process 700 may include one or more fewer, additional, differently ordered and/or arranged operations than those shown in FIG. 7. For example, process 600 may include operations for SSB/PBCH and SIB1 transmissions (blocks 410 and/or 420) described above with reference to FIG. 4. In some implementations, some or all of the operations of process 700 may be performed independently, successively, simultaneously, etc., of one or more of the other operations of process 700. As such, the techniques described herein are not limited to a number, sequence, arrangement, timing, etc., of the operations or processes depicted in FIG. 7.

Process 700 may include UE 210 receiving a RA preamble assignment from base station 222 operating as a TRP (at 710). A CFRA procedure may involve base station 222 sending UE 210 an SIB index, PRACH preamble, RO, and one or more additional types of information. This may be sent by base station 222 as system information. UE 210 may respond to base station 222 by sending the RA preamble in a MsgA-PRACH message (at 720). UE 210 may also send a PUSCH payload in a MsgA-PUSCH message (at 720). Since the RA preamble in process 700 was selected by base station 222, process 700 may be a CFRA procedure since base station 222 may not receive a competing message from another UE 210 using the same RA preamble. The MsgA-PRACH message and the MsgA-PUSCH message may include information similar to MSG 1 and MSG 3 of a 4-step RACH procedure. Base station 222 may respond with a RAR via a MsgB message (at 740). A RAR message may include information, such as a TA command for timing adjustment, a RAPID matching the preamble sent by UE 210, and an initial UL grant for UE 210 to continue sending information to base station 222. A RAR may also include a temporary identifier of base station 222, which may include a RA-RNTI. The MsgB message may be similar to a MSG 3 RAR of a 4-step RACH procedure. Upon receiving the RAR message, UE 210 and base station 222 may proceed to exchange UL and/or DL communications with one another (at 750).

In some implementations, base station 222 may be a main TRP that send DL communications to UE 210 directly and receives UL communications from UE 210 via a UL-only TRP (not shown). In some impetrations, base station 222 may be a UL-only TRP that only receives UL communications from UE 210 and relays the UL communications to a main TRP. Additional example of these and other features and implementations are described below with reference to the Figures that follow.

FIG. 8 is a diagram of an example of a process 800 for determining whether to configure UE for UL-only TRPs according to one or more implementations described herein. Process 800 may be implemented by base station 222 operating as a main TRP with respect to UE 210. In some implementations, some or all of process 400 may be performed by one or more other systems or devices, including one or more of the devices of FIG. 2. Additionally, process 800 may include one or more fewer, additional, differently ordered and/or arranged operations than those shown in FIG. 8. In some implementations, some or all of the operations of process 800 may be performed independently, successively, simultaneously, etc., of one or more of the other operations of process 800.

As shown, process 800 may include determining whether UL-only communications are supported (block 810). For example, base station 222 may determine whether base station 222 is capable of operating as a main TRP with respect to a particular UE 210. Additionally, or alternatively, base station 210 may determine whether one or more other base stations 222 (or cells) are capable of operating as a UL-only TRB relative to a particular UE 210 and/or relative to base station 222 operating as a main TRP. In some implementations, the determination performed by base station 222 may be part of a dynamically operation that may depend on one or more conditions, such as network congestion, signal interference, TRP availability, etc. In some implementations, the determination performed by base station 222 may be based on a static configuration of base station 222.

When UL-only TRP is not supported (block 820—No), base station 222 may refrain or forego configuring UE 210 for UL-only TRP communications (block 830). For example, base station 222 may proceed by sending UE 210 an SIB1 that does not include configuration information that may cause, enable, or otherwise configure UE 210 to communicate with base station 222 via a UL-only TRP. When UL-only TRP is supported (block 820—Yes), base station 222 may proceed by sending UE 210 information that may cause, enable, or otherwise configure UE 210 to communicate with base station 222 via a UL-only TRP (block 840). The configuration information may be included in SIB1, and examples and details of such information are discussed below.

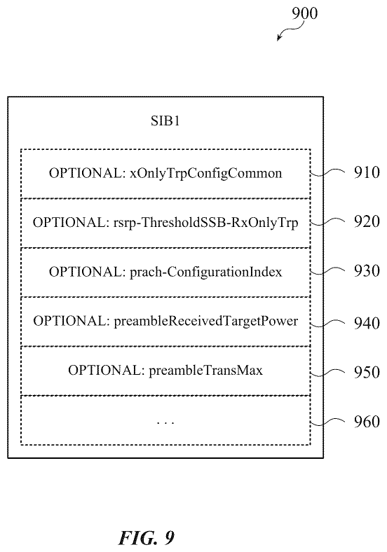

FIG. 9 is an example of information 900 that may be included in SIB1 according to one or more implementations described herein. As shown, information 900 may include one or more types of information elements (IEs) and/or parameters 910-660. While FIG. 9 indicates specific IEs and/or parameters 910-960, the techniques described herein may include similar or analogous IEs and/or parameters to those depicted. As such, the techniques described herein are not limited to IEs and/or parameters 910-960.

Generally, SIB1 may include configuration information to enable UE 210 to communicate with a main TRP via a UL-only TRP. For example, when a main TRP supports UL-only TRPs, SIB1 may include RxOnlyTrpConfigCommon 910, which may be part of an ServingCellConfigCommonSIB IE. In some implementations, RxOnlyTrpConfigCommon 910 may instead by provided by dedicated signaling (e.g., and RRC message). RxOnlyTrpConfigCommon 910 may be provided in addition to an uplinkConfigCommon IE for direct communication between UE 210 and the main TRP. In some implementations, UE 210 may not be configured with a supplementaryUplinkConfig IE and an RxOnlyTrpConfigCommom IE when supplemental UL (SUL) and UL-only TRP are both supported. In such scenarios, SIB1 may include configuration information (e.g., an IE or parameter) for one but not the other.

In some implementations, SIB1 may include a threshold parameter (e.g., rsrp-ThresholdSSB-RxOnlyTrp 920) associated with the UL-only TRP. The threshold parameter may be a threshold for a reference signal received power (RSRP). UE 210 may use the threshold parameter for selection between the main TRP and the UL-only TRP. For example, UE 210 may transition from sending UL communications to the main TRP to sending UL communications to the UL-only TRP when an RSRP associated with the main TRP is below the threshold parameter (e.g., the RSRP threshold). In another example, RACH occasions (ROs) and/or preambles associated to each SSB may be partitioned between, or associated with, RACH procedures toward the main TRP or RACH procedures toward the UL-only TRP. A RO may include one or more time and frequency resources designated for initiating or performing a RACH procedure. SIB1 may include an indication of ROs and preambles (PAs) that UE 210 may use to initiate or perform a RACH procedure with a base station.

In another example, SIB1 may include a RACH-ConfigGeneric IE, in RACH-ConfigCommon, which may include different values to indicate whether UE 210 is to perform a PRACH operation toward a regular TRP or a UL-only TRP. A prach-ConfigurationIndex 930 may include two values for different types of TRPs. One value may correspond to a long format RACH since a long format RACH may provide more coverage for UEs 210 communicating with a main or main TRP. The other value may correspond to a short format RACH since for a UE 210 at a cell-edge of a main TRP but close to a UL-only TRP, a short format RACH may be preferred. In other implementations, a single IE parameter or value may be used but interpreted differently depending on the scenario. For example, the value may be mapped to a short format for a RACH procedure directed to a main TRP. By contrast, for a RACH procedure directed to a UL-only TRP, the value may be mapped to a long PRACH procedure and/or according to an FR2 approach, where a single index may be mapped to entries in different tables (e.g., a table for frequency range 1 (FR1) and/or frequency range 2 (FR2).

In some implementations, RACH-ConfigGeneric (e.g., of RACH-ConfigCommon) may include preambleReceivedTargetPower 940. The value of preambleReceivedTargetPower 940 may be less for RACH procedures directed toward a UL-only TRP relative to the value for RACH procedures directed toward a main TRP or a regular TRP. In some scenarios, this may be because when UE 210 is located at a cell edge of the main TRP, UE 210 may be relatively close to the UL-only TRP, in which case a lower value of preambleReceivedTargetPower 940 may be adequate or more efficient. In some implementations, RACH-ConfigGeneric (e.g., of RACH-ConfigCommon) may include preambleTransMax 950. In such scenarios, a value of preambleTransMax 950 may better ensure that UL transmissions do not interfere with UL signals from other UEs 210 attempting to communicate with the main TRP. As shown, SIB1 may also, or alternatively, include one or more IEs or parameters 960 to enable UE 210 to communicate via a UL-only TRP.

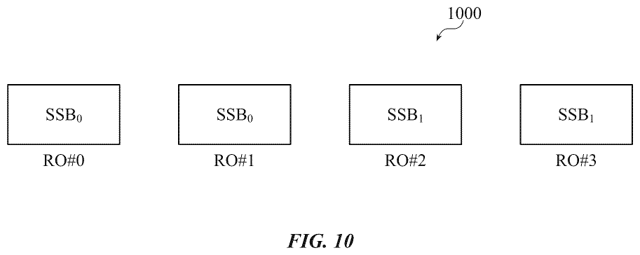

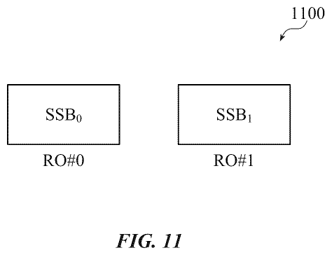

FIGS. 10-11 are examples 1000 and 1100 of ROs associated with different SSBs according to one or more implementations described herein. As mentioned above, SIB1 may indicate to UE 210 that base station 222 may communicate additional SIBs. Each RACH resource (e.g., RO and/or preamble (PA)) may be associated to an SSB block. This may enable the NW (e.g., base station 222) to know a direction of UE 210). UE 210 may performs a RACH procedure on the resource associated with the strongest SSB RSRP. Each SSB may be mapped into a different/orthogonal RACH resource. Some RACH resources may be used for RACH toward the UL-only TRP, while some other RACH resources may be used for RACH toward regular TRP. In example 1 (e.g., FIG. 10), orthogonal RACH resources may be achieved through orthogonal RACH occasions where each SSB is associated to two different ROs (and each occasion has 4 preambles), while in example 2 (e.g., FIG. 11), orthogonal RACH resources may be achieved through separate RACH preambles where each SSB is associated to one RO with 8 preambles in each RO, 4 preambles are assigned for RACH toward macro TRP and 4 preambles are assigned for RACH toward UL only TRP.

Referring to FIG. 10, a first RO (RO #0) and a second RO (RO #1) may be associated with SSB₀. A third RO (RO #2) and a fourth RO (RO #3) may each be associated with an SSB₁. SSB₀ and SSB₁ may each be instances of an SIB1. SSB₀ may be an instance of SIB1 for a main TRP, and SSB₀ may be an instance of SIB1 for a UL-only TRP. Each SSB may be associated with two ROs, and each RO may be associated with 4 preambles. This may include two long PAs and two short PAs, or another arrangement of PAs. Additionally, ROs for the main TRP (e.g., RO #0 and RO #1) may be separate from ROs for the UL-only TRP (e.g., RO #2 and RO #3), which may be represented by the following IEs and parameters.

ssb-perRACH-OccasionAndCB-PreamblesPerSSB {oneHalf, n4}
msg1-FDM = 1

Referring to FIG. 11, in some implementations, two SSB RO combinations may be used. As shown, a first RO (RO #0) may be associated with SSB₀. A second RO (RO #1) may be associated with SSB₁. SSB₀ and SSB₁ may each be instances of an SIB1. SSB₀ may be an instance of SIB1 for a main TRP, and SSB₀ may be an instance of SIB1 for a UL-only TRP. Each SSB may be associated to one RO with 4 PAs. Some PAs may be for communicating with the main TRP, while other PAs may be for communicating with a UL-only TRP, which may be represented by the following IEs and parameters.

ssb-perRACH-OccasionAndCB-PreamblesPerSSB {one, n8}
msg1-FDM = 1

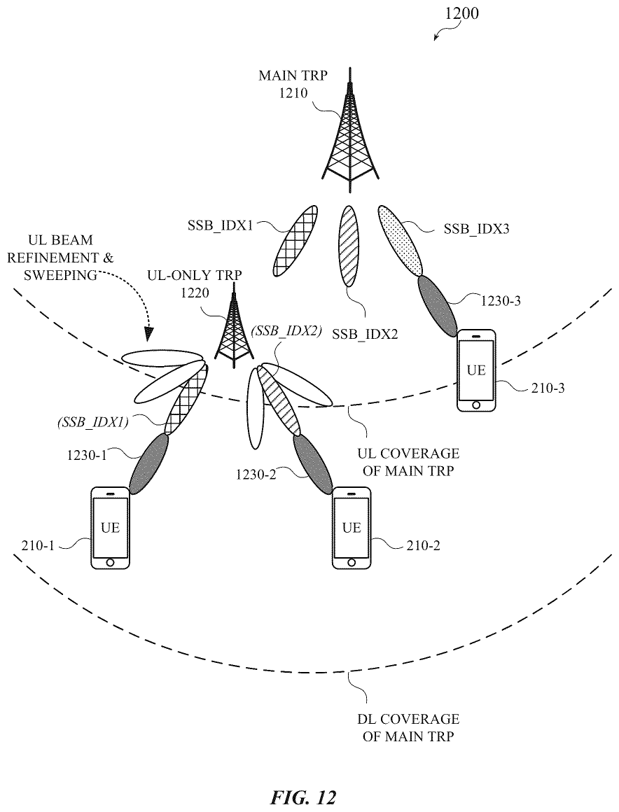

FIG. 12 is a diagram of an example 1200 for implementing a UL-only operation together with a main TRP operation according to one or more implementations described herein. As shown, example 1200 may include main TRP 1210, UL-only TRP 1220, and UEs 210-1, 210-2, and 210-3. Main TRP 1210 may be implemented by a base station 222 operating as a PCell or main TRP. UL-only TRP 1220 may be implemented by another base station operating as an SCell or Rx-only TRP. Main TRP 1210 may include coverage area for UL transmissions and a different coverage area for DL transmission. As shown, the coverage area for DL transmissions may be further from main TRP 1210 than the coverage area for UL transmission.

Main TRP 1210 may be configured to communicate different SSB1 signals via different beams (e.g., SIB_IDX1, SIB-IDX2, and SSB-IDX3), and UEs 210-1, 210-2, and 210-3 may communicate with TRPs 1210 and 1220 via beams 1230-1, 1230-2, and 1230-3, respectively. For RACH procedures toward UL-only TRP 1220, UEs 210-1 and 210-2 may communicate multiple MSG 1 transmissions using the same UL beam over different ROs, where each RO is associated with a corresponding SIB. For example, UE 210-1 may communicate a MSG 1 transmission according to a RO associated with SSB_IDX1; UE 210-2 may communicate a MSG 1 transmission according to a RO associated with SSB_IDX2; and UE 210-3 may communicate a MSG 1 transmission according to a RO associated with SSB_IDX3. In some implementations, UL-only TRP 1220 may perform beam sweeps to connect with UEs 210-1 and 210-2s. Additionally, or alternatively, UL-only TRP 1220 determine the direction of a UL-only beam for a UE 210 based on a relative direction of a DL beam used by main TRP 1210 to communicate with the corresponding UE 210. Additionally, or alternatively, UEs 210-1 and 210-2 may perform a UL beam refinement and/or sweeping procedure when performing a RACH procedure directed toward UL-only TRP 1220. UEs 210-1, 210-2, and 210-3 may communicate different MSG 1 transmissions during the RACH procedure, which may result in an extension of a duration (or a number of slots) of a window for a MSG 2 response (e.g., a ra-ResponseWindow).

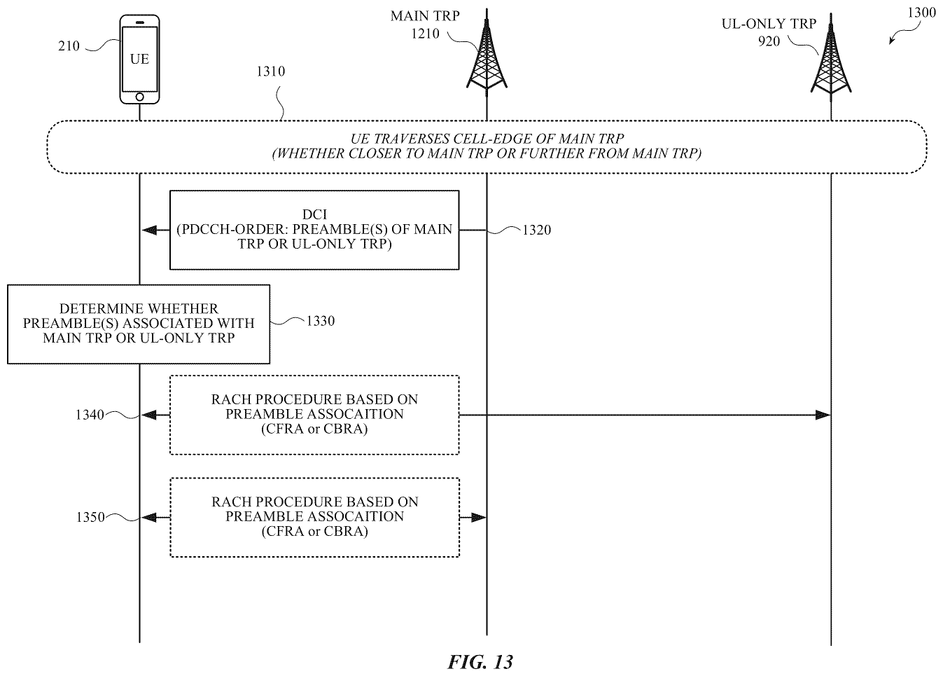

FIG. 13 is a diagram of an example of a process 1300 for transitioning between UL communications toward a main TRP and a UL-only TRP according to one or more implementations described herein. As shown, process 1300 may include UE 210, main TRP 1210, and UL-only TRP 1220. Process 1300 may be performed by one or more other systems or devices, including one or more of the devices of FIG. 2. Main TRP 1210 may be implemented by a base station 222 operating as a PCell or main TRP with respect to UE 210. UL-only TRP 1220 may be implemented by another base station operating as an SCell or Rx-only TRP with respect to UE 210. Additionally, process 1300 may include one or more fewer, additional, differently ordered and/or arranged operations than those shown in FIG. 13. In some implementations, some or all of the operations of process 1300 may be performed independently, successively, simultaneously, etc., of one or more of the other operations of process 1300. As such, the techniques described herein are not limited to the number, sequence, arrangement, timing, etc., of the operations or processes depicted in FIG. 13.

As shown, UE 210 may traverse a cell-edge of main TRP (at 1310). For example, UE 210 may be located within a UL coverage area of main TRP 1210 and move to a location outside of the UL coverage. Alternatively, UE 210 may be located beyond a UL coverage area of main TRP 1201 and move within a UL coverage area of main TRP 1210. In either scenario, UE 210 may maintain a DL connection with main TRP 1210. Main TRP 1210 may determine the change in location of UE 210 and/or may transmit configuration information to UE 210 based on the change in location. For example, main TRP 1210 may transmit DCI to UE 210 (at 1320).

DCI format 1_0 or another type of DCI format may be used. The DCI may include a PDCCH-Order IE using DCI format 1_0. In some implementation, the DCI may include a random access (RA) preamble index. UE 210 may determine whether the preamble is associated with main TRP 1210 or UL-only TRP 1220 (at 1330). This may be because preambles and/or ROs, associated with each SSB, may be allocated for a RACH procedure toward main TRP 1210 or UL-only TRP 1220. UE 210 may also, or alternatively, perform a RACH procedure toward main TRP 1210 (1040) or a RACH procedure toward UL-only TRP 1220 (at 1350) based on the preamble(s). When the DCI includes a preamble, the RACH procedure may be contention-free random access (CFRA) procedure. In other implementations, the DCI may not include a preamble. Instead, the DCI may include a 1-bit indicator in the PDCCH-Order IE, which UE 210 may use to determine whether to perform a RACH procedure toward main TRP 1210 or UL-only TRP 1220. When the DCI does not include a preamble, UE 210 may select a preamble for main TRP 1210 or UL-only TRP 1220 (per the 1-bit indicator) and perform a contention-based random access (CBRA) procedure.

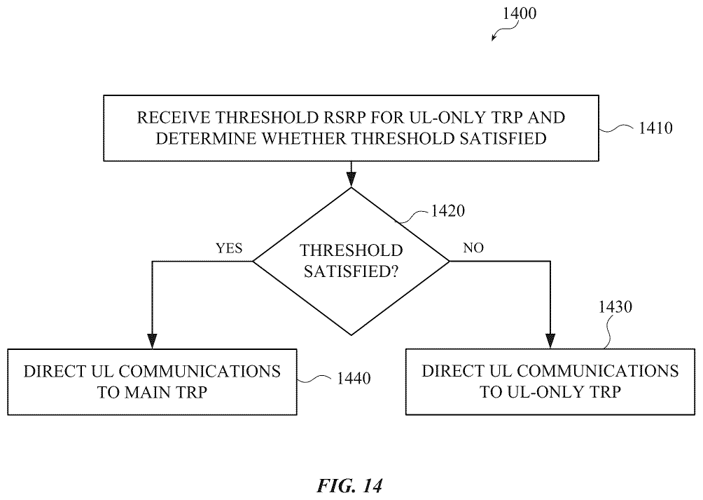

FIG. 14 is a diagram of an example of a process 1400 for transitioning between UL communications toward a main TRP and a UL-only TRP according to one or more implementations described herein. As shown, process 1400 may be performed by UE 210. In some implementations, process 1400 may be performed by one or more other systems or devices, including base station 222 operating as main TRP 1210 or base station 222 operating as UL-only TRP 1220. Additionally, process 1400 may include one or more fewer, additional, differently ordered and/or arranged operations than those shown in FIG. 14. In some implementations, some or all of the operations of process 1400 may be performed independently, successively, simultaneously, etc., of one or more of the other operations of process 1400. As such, the techniques described herein are not limited to the number, sequence, arrangement, timing, etc., of the operations or processes depicted in FIG. 14.

As shown, process 1400 may include receiving a threshold RSRP for communicating with UL-only TRP 1220 and determining whether the threshold RSRP is satisfied (block 1410). For example, base station 222 may provide UE 210 with control information indicating threshold RSRP for communicating with UL-only TRP 1220. The threshold RSRP may be included in an rsrp-ThresholdSSB-RxOnlyTrp-delta IE, which may be received via a higher layer configuration (e.g., RRC information). The threshold RSRP may include a threshold value or a change in a value, corresponding to a measured RSRP, for triggering a switch between UL communications toward main TRP 1210 and UL-only TRP 1220. The threshold RSRP may correspond to an RSRP from measured RSRP or an RSRP from UL-only TRP 1220. UE 210 may monitor and measure the RSRP and determine whether the measured RSRP satisfies RSRP.

When the threshold RSRP is not satisfied (1120—No), process 1400 may include directing UL communications to UL-only TRP 1220 (block 1430). For example, when the measured RSRP is from main TRP 1210 and does not satisfy the threshold RSRP (e.g., because UE 210 is too far away from main TRP 1210), UE 210 may perform a RACH procedure toward UL-only TRP 1220. If UE 210 is already communicating with UL-only TRP 1220, UE 210 may continue to direct communications toward UL-only TRP 1220. The RACHH procedure may be a CBRA procedure unless UE 210 receives control information indicating a preamble and/or RO associated with main TRP 1210 or UL-only TRP 1220.

When the threshold RSRP is satisfied (1120—Yes), process 1400 may include directing UL communications to UL-only TRP 1220 (block 140). For example, when the measured RSRP is from main TRP 1210 and does satisfy the threshold RSRP (e.g., because UE 210 is not too far away from main TRP 1210), UE 210 may perform a RACH procedure toward main TRP 1220. If UE 210 is already sending UL communications to main TRP 1210, UE 210 may continue to direct communications toward UL-only TRP 1220. The RACHH procedure may be a CBRA procedure unless UE 210 receives control information indicating a preamble and/or RO associated with main TRP 1210 or UL-only TRP 1220.

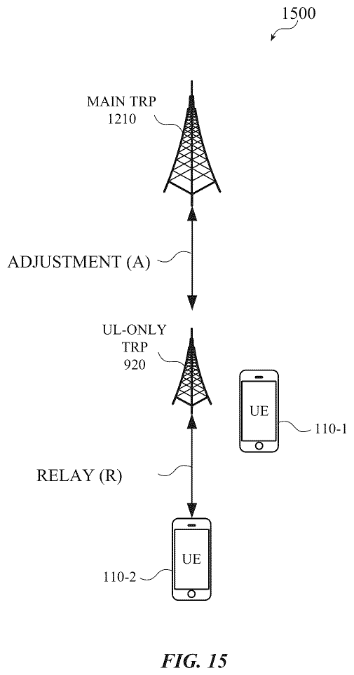

FIG. 15 is a diagram of an example 1500 for providing an effective TA for UL-only TRP 1220 according to one or more implementations described herein. As shown, example, 1500 may include main TRP 1210, UL-TRP 1220, UE 210-1, and UE 210-2. UE 210-1 and UE 210-2 may receive DL communications from main TRP 1210 and transmit UL communications to UL-only TRP 1220. The TA may include a command or notification from main TRP 1210 or UL-TRP 1220 to UE 210 that cause or enable UE 210 to adjust a transition time for UL communications. The TA techniques may be applicable to communications for RACH procedures and/or while UEs 210 are in an RRC connected mode.

UL-only TRP 1220 may determine and indicate an effective TA to UE 210-1 and UE 210-2. The effective TA for UE 210-1 may be different than the effective TA for UE 210-2 because of the different DL timings of UE 210-1 and UE 210-2 given their different distances from main TRP 1210. UL-only TRP 1220 may determine an effective TA by subtracting a propagation delay (A) between UL-only TRP 1220 and main TRP 1210 from a calculated TA at UL-only TRP 1220. For example, a calculated TA before adjustment for UE 210-1 may be equal to A since UE 210-1 is at or near UL-only TRP 1220. As such, an effective TA before adjustment for UE 210-1 may be determined as A−A=0. By contrast, because of the added distance R between UL-only TRP 220 and UE 210-2, a calculated TA before adjustment may be determined as equal to A+2R (e.g., A+R+R), and an effective TA before adjustment at UL-only TRP 1220 may be equal to A+2R−A (e.g., 2R).

UL-only TRP 1220 may provide UE 210-1 and UE 210-2 with an effective TA and/or corresponding TA command, and UE 210-1 and UE 210-2 may use the effective TAs in reference to DL communications received from main TRP 1210, but due the adjustment A being included in each effective TA, UL communications from UE 210-1 and UE 210-2 may be received by UL-only TRP 1220 simultaneously. Alternatively, UL timing for UEs 210 transmitting PRACH signals toward UL-only TRP 1220 may be based on a global time reference (instead of a DL reception time at each given UE). In such implementations, when the TA is issued by UL-only TRP 1220, UEs 210 may apply the TA in reference to the global timing reference (instead of the DL reception time which is different for different UEs 210).

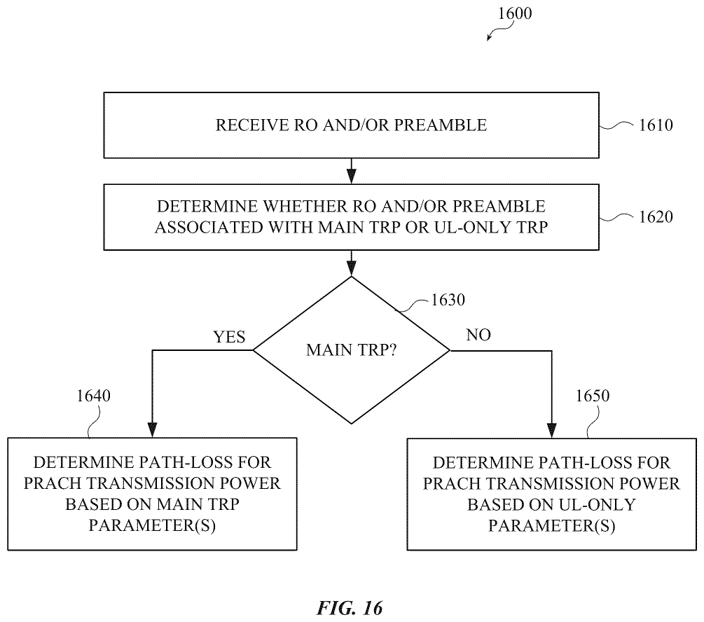

FIG. 16 is a diagram of an example of a process 1600 for transmission power control based on path loss (PL) according to one or more implementations described herein. Process 1600 may correspond to determining transmission power for PRACH transmissions. Process 1600 may be performed by UE 210. In some implementations, process 1600 may be performed by one or more other systems or devices, including base station 222 operating as main TRP 1210 or as UL-only TRP 1220. Additionally, process 1600 may include one or more fewer, additional, differently ordered and/or arranged operations than those shown in FIG. 16. In some implementations, some or all of the operations of process 1600 may be performed independently, successively, simultaneously, etc., of one or more of the other operations of process 1600. As such, the techniques described herein are not limited to the number, sequence, arrangement, timing, etc., of the operations or processes depicted in FIG. 16.

Process 1600 may include obtaining an RO and/or preamble (block 1610). For example, UE 210 may obtain a RO and/or preamble for a RACH procedure. In some implementations, the RO and/or preamble may be provided by base station 222. In some implementations, the RO and/or preamble may be selected and determined by UE 210 randomly.

Process 1600 may include determining whether the RO and/or preamble are associated with main TRP 1210 or UL-only TRP 1220 (block 1620). For example, UE 210 may determine whether the RO and/or preamble for a RACH procedure is associated with main TRP 1210 or UL-only TRP 1220. In some implementations, UE 210 may be configured with an index or repository of configuration information that associates some ROs and/or preambles with main TRP 1210 and other ROs and/or preambles with UL-only TRP 1220. In such scenarios, UE 210 may determine whether a particular RO and/or preamble pertains to main TRP 1210 or UL-only TRP 1220 by comparing the RO and/or preamble to the configuration information.

When the RO and/or preamble is associated with main TRP 1220 (block 1630—Yes), process 1600 may include determining a PL for a RACH transmission power based on main TRP parameters (block 1640). When the RO and/or preamble is associated with UL-only TRP 1220 (block 1630—Yes), process 1600 may include determining a PL for a RACH transmission power based on UL-only TRP parameters (block 1650). For example, for a RACH transmission over UL bandwidth part (BWP) B of carrier F of serving cell C, a PL for a RACH transmission power may be determined based on PL_{BFC} minus a delta value D. PL_{BFC} may be determined based on a measured RSRP of a SS/PBCH block corresponding to the RACH transmission. Delta value D may be equal to zero when a RO and/or a preamble is associated with main TRP 1210. Delta value D may be greater than or equal to zero when a RO and/or a preamble is associated with UL-only TRP 1210. For instance, when a measured RSRP is less than a power threshold (e.g., a rsrp-ThresholdSSB-RxOnlyTrp value), UE 210 may transmit MSG 1 over the RACH resources associated to UL-only TRP 1220 and corresponding to the SS/PBCH transmission.

Additionally, or alternatively, when a RACH transmission from UE 210 is not in response to receiving a corresponding instruction (e.g., a PDCCH-Order IE) from main TRP 1210) the delta value D may be configured by configuration information (e.g., a RACH-ConfigCommon IE) and may be subject to a power threshold (e.g., a rsrp-ThresholdSSB-RxOnlyTrp IE). For example, when a measured RSRP satisfies the power threshold, delta value D may be zero, but when the measured RSRP does not satisfy the power threshold, delta value D may be configured or indicated by the configuration information. The configuration information not indicating a delta value D for such scenarios may be an indication that base station 222 does not support UL-only TRP scenarios.

In some implementations, the configuration information (e.g., a RACH-ConfigCommon IE) may include a set of delta values D. In some implementations, RACH-ConfigCommon may include 4 possible values indicated by a 2-bit field in DCI, which may map to different delta values. In such scenarios, UE 210 may determine that the delta value D is zero when DCI indicates a RACH procedure toward main TRP 1210. When DCI indicates a RACH procedure toward UL-only TRP 1220, UE 210 may determine that the delta value D based on the 2-bit field being mapped to a delta value D.

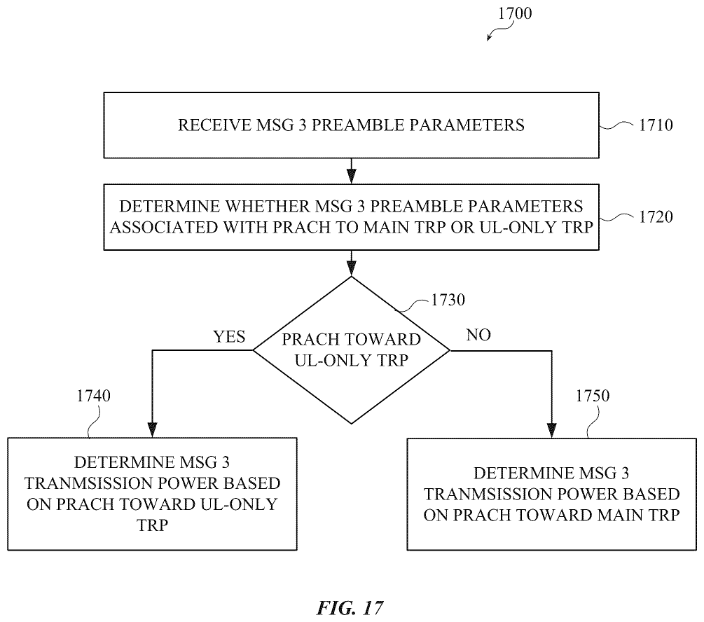

FIG. 17 is a diagram of an example of a process 1700 for transmission power control for PUSCH transmissions during a PRACH procedure according to one or more implementations described herein. Process 1700 may correspond to determining transmission power for MSG 3 transmission via a PUSCH. Process 1700 may be performed by UE 210. In some implementations, process 1700 may be performed by one or more other systems or devices, including base station 222 operating as main TRP 1210 or as UL-only TRP 1220. Additionally, process 1700 may include one or more fewer, additional, differently ordered and/or arranged operations than those shown in FIG. 17. In some implementations, some or all of the operations of process 1700 may be performed independently, successively, simultaneously, etc., of one or more of the other operations of process 1700. As such, the techniques described herein are not limited to the number, sequence, arrangement, timing, etc., of the operations or processes depicted in FIG. 17.

Process 1700 may include receiving MSG 3 preamble parameters (block 1710). For example, UE 210 may receive configuration information corresponding to MSG 3 transmission. In some implementations, this may include a msg3-DeltaPreamble IE of a PUSCH-ConfigCommon IE. The msg3-DeltaPreamble IE may indicate a power offset (e.g., 2×(−1 . . . 6) dB) between MSG 3 and RACH preamble transmissions for RACH procedure communications toward main TRP 1220. UE 210 may also, or alternatively, receive a msg3-DeltaPreamble_RxonlyTrp IE, which may indicate a power offset between MSG 3 and RACH preamble transmissions for RACH procedure communications directed toward UL-only TRP 1220. In some implementations, the power offset may be 2×(−6 . . . 1) dB.

Process 1700 may include determining whether the MSG 3 preamble parameters are associated with main TRP 1210 or UL-only TRP 1220 (block 1720). For example, UE 210 may determine whether the MSG 3 preamble parameters for a RACH procedure may be associated with main TRP 1210 or UL-only TRP 1220. A msg3-DeltaPreamble IE may be associated with main TRP 1210, and a msg3-DeltaPreamble_RxonlyTrp IE may be associated with UL-only TRP 1220. When the MSG 3 preamble parameters are associated with UL-only TRP 1220 (block 1730—Yes), process 1700 may include determining MSG 3 transmission power for PRACH toward UL-only TRP 1210 (block 1740). When the MSG 3 preamble parameters are not associated with UL-only TRP 1220 (block 1730—No), process 1700 may include determining MSG 3 transmission power based on a PRACH toward main TRP 1210 (block 1750).

For MSG 3 transmissions while RRC connected over UL BWP B of carrier F of serving cell C, UE 210 may be configured with two msg3-Alpha parameters. For MSG 3 transmissions toward main TRP 1210, UE 210 may determine transmission power base on a msg3-Alpha parameter. For MSG 3 transmissions toward UL-only TRP 1220, UE 210 may determine transmission power base on a msg3-Alpha_RxonlyTrp parameter. Additionally, or alternatively, for MSG 3 transmissions over UL BWP B of carrier F of serving cell C, UE 210 may be configured to transmit PRACH signals toward UL-only TRP at a fixed configured power. In such scenarios, the fixed configured power may be indicated by a referenceSignalPowerPrach IE, and UL-only TRP 210 may calculate PL based on the transmit PRACH signals.

In some implementations, UE 210 may be configured to use different transmission power parameters implicitly or explicitly. In some implementations, UE 210 may be implicitly configured to use a msg3-DeltaPreamble IE or a msg3-DeltaPreamble_RxonlyTrp IE when an MSG 3 transmission is scheduled by a RAR UL grant resulting from a RACH procedure over a RO and/or preambles associated with UL-only TRP 1220. In some implementations, UE 210 may be implicitly configured to use a msg3-DeltaPreamble IE or a msg3-DeltaPreamble_RxonlyTrp IE based on a reserved 1-bit indicator in MSG 3 configuration information received by UE 210.

Additionally, or alternatively, UE 210 may implement transmission power control techniques involving PUXCH, PUCCH, and SRS transmissions. In some implementations, UE 210 may be configured transmit SRS signals at a fixed power. The fixed power may be indicated by control information, such as a referenceSignalPowerSrs IE, from base station 222. The network may determine a PL for the SRS signals at UL-only TRP 1220. In some implementations, UE 210 may determine the transmission power for SRS signals based on implicit conditions. For example, when SRS transmission is indicated after PDCCH order using DCI format 1_0 to perform RACH over using preambles associated to Rx only TRP, UE 210 may transmit SRS signals with the configured fixed power based on the referenceSignalPowerSrs IE. In some implementations, UE 210 may determine the transmission power for SRS signals based on implicit conditions. For example, an SRS resource configuration may be associated with a given referenceSignalPowerSrs. Once the SRS resource is activated in an SRS request bit-field (or similar procedure for P/SP-SRS), UE 210 may determine a transmission power for SRS signals based on a configured fixed power, which may be indicated in the referenceSignalPowerSrs IE. Main TRP 1210 may determine a PL for signaling from UE 210 to UL-only TRP 1220, and may indicate the PL to UE 210 via configuration information, such as a MAC control element (CE), DCI signaling, etc.

In some implementations, base station 222 may provide UE 210 with configuration informatic indicating different (Po, α) sets (e.g., one for UL communications directed toward main TRP 1210 another for UL communications directed toward UL-only TRP 1220). A (Po, α) may be used by UE 210 as a target received power (Po) at the receiver and a path loss (PL) compensation factor (α). The control information (e.g., DCI or a configured grant (CG) configuration may include a 1-bit field or a 2-bit field indicating which (Po, α) set is to be used by UE 210. Main TRP 1210 may determine a PL for PUCCH and/or SRS transmissions from UE 210 to UL-only TRP 1220 and may indicate the PL to UE 210 via configuration information, such as a MAC control element (CE), DCI signaling, etc.

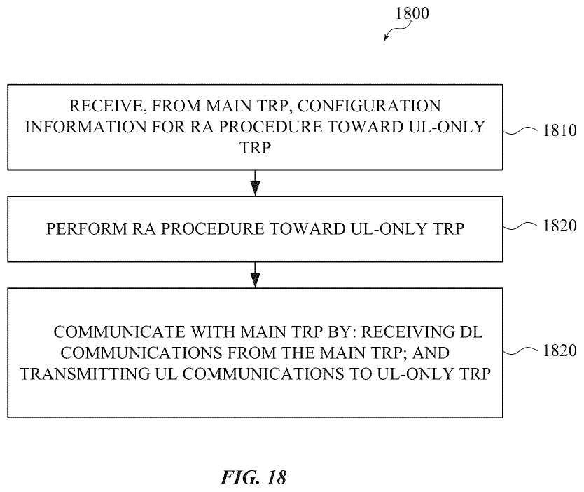

FIG. 18 is a diagram of an example of a process 1800 for signaling and procedure for communication to UL-only TRP 1220 according to one or more implementations described herein. Process 1800 may be performed by UE 210. Additionally, process 1800 may include one or more fewer, additional, differently ordered and/or arranged operations than those shown in FIG. 18. In some implementations, some or all of the operations of process 1800 may be performed independently, successively, simultaneously, etc., of one or more of the other operations of process 1800. As such, the techniques described herein are not limited to the number, sequence, arrangement, timing, etc., of the operations or processes depicted in FIG. 18.

As shown, process 1800 may include receiving, from main TRP 1220, configuration information for a RA procedure toward another base station 222 operating as an UL-only TRP (block 1810). Process 1800 may also include performing a RA procedure toward the UL-only TRP (block 1820). Process 1800 may also include communicating with the main TRP by receiving DL communications from the main TRP and transmitting UL communications to the UL-only TRP (block 1830).

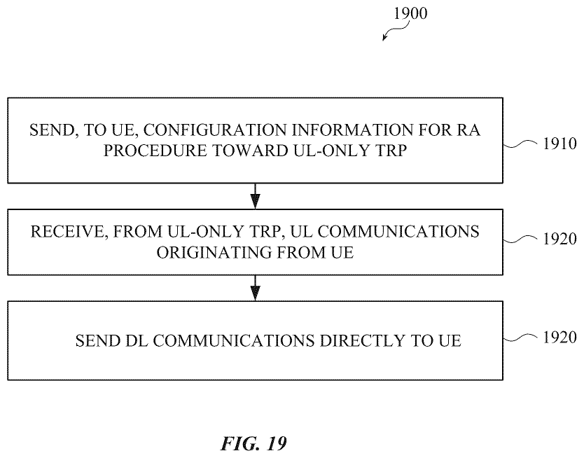

FIG. 19 is a diagram of an example of a process 1900 for signaling and procedure for communication to UL-only TRP 1220 according to one or more implementations described herein. Process 1900 may be performed by main TRP 1210. Additionally, process 1900 may include one or more fewer, additional, differently ordered and/or arranged operations than those shown in FIG. 19. In some implementations, some or all of the operations of process 1900 may be performed independently, successively, simultaneously, etc., of one or more of the other operations of process 1900. As such, the techniques described herein are not limited to the number, sequence, arrangement, timing, etc., of the operations or processes depicted in FIG. 19.

As shown, process 1900 may include sending, to UE 210, configuration information for RA procedure toward UL-only TRP (block 1910). Process 1900 may also include receiving, from UL-only TRP, UL communications originating from UE 210 (block 1920). Process 1900 may also include sending DL communications directly to UE 210 (block 1930).

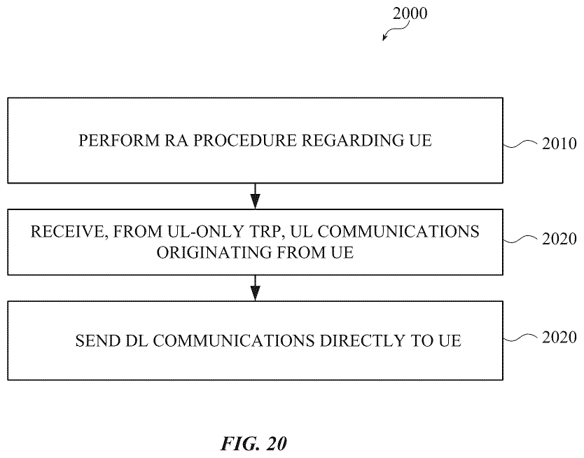

FIG. 20 is a diagram of an example of a process 2000 for signaling and procedure for communication to UL-only TRP 1220 according to one or more implementations described herein. Process 2000 may be performed by UL-only TRP 1220. Additionally, process 2000 may include one or more fewer, additional, differently ordered and/or arranged operations than those shown in FIG. 20. In some implementations, some or all of the operations of process 2000 may be performed independently, successively, simultaneously, etc., of one or more of the other operations of process 2000. As such, the techniques described herein are not limited to the number, sequence, arrangement, timing, etc., of the operations or processes depicted in FIG. 20.

As shown, process 2000 may include performing RA procedure regarding UE 222 (block 2010). Process 2000 may also include operating as UL-only TRP 1220 for UE 222 and main TRP 1210 by: receiving UL communications from UE 210; and sending the UL communications to main TRP 1210 (block 2030).

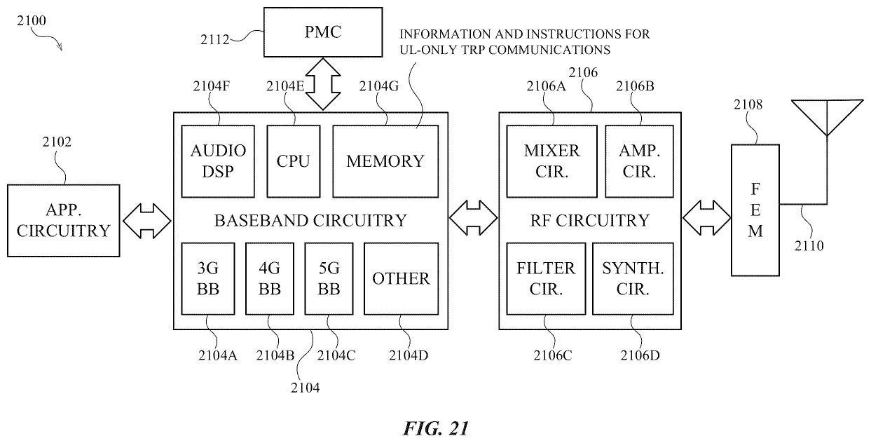

FIG. 21 is a diagram of an example of components of a device according to one or more implementations described herein. In some implementations, device 2100 can include application circuitry 2102, baseband circuitry 2104, RF circuitry 2106, front-end module (FEM) circuitry 2108, one or more antennas 2110, and power management circuitry (PMC) 2112 coupled together at least as shown. In some implementations, device 2100 can include fewer elements (e.g., a RAN node may not utilize application circuitry 2102 and can instead include a processor/controller to process data received from a core network. In some implementations, device 2100 can include additional elements such as, for example, memory/storage, display, camera, sensor (including one or more temperature sensors, such as a single temperature sensor, a plurality of temperature sensors at different locations in device 2100, etc.), or input/output (I/O) interface. In other implementations, the components described below can be included in more than one device (e.g., said circuitries can be separately included in more than one device for cloud-RAN (C-RAN) implementations).

Application circuitry 2102 can include one or more application processors. For example, application circuitry 2102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 2100. In some implementations, processors of application circuitry 2102 can process data packets received from a core network.

Baseband circuitry 2104 can include circuitry such as, but not limited to, one or more single-core or multi-core processors. Baseband circuitry 2104 can include one or more baseband processors or control logic to process baseband signals received from a receive signal path of RF circuitry 2106 and to generate baseband signals for a transmit signal path of RF circuitry 2106. Baseband circuitry 2104 can interface with application circuitry 2102 for generation and processing of the baseband signals and for controlling operations of RF circuitry 2106. For example, in some implementations, baseband circuitry 2104 can include a 3G baseband processor 2104A, a 4G baseband processor 2104B, a 5G baseband processor 2104C, or other baseband processor(s) 2104D for other existing generations, generations in development or to be developed in the future (e.g., 5G, 6G, 7G, etc.). Baseband circuitry 2104 (e.g., one or more of baseband processors 2104A-D) can handle various radio control functions that enable communication with one or more radio networks via RF circuitry 2106. In other implementations, some or all of the functionality of baseband processors 2104A-D can be included in modules stored in memory 2104G and executed via a central processing unit (CPU) 2104E. The radio control functions can include, but are not limited to, signal modulation/demodulation, encoding/decoding, radio frequency shifting, etc. In some implementations, modulation/demodulation circuitry of baseband circuitry 2104 can include Fast-Fourier Transform (FFT), precoding, or constellation mapping/de-mapping functionality. In some implementations, encoding/decoding circuitry of baseband circuitry 2104 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 2104G may receive and/or store information and instructions for enabling UE 210 to communicate with a UL-only TRP as described herein. The UL-only TRP may include a first base station 222 operating as an SCell, and a second base station 222 operating as a main TRP or PCell. Information and instructions 2255 may also enable determining a TA for UL communications, controlling UL transmission power, and managing beams for UL communications between a UE and the UL-only TRP. Information and instructions 2255 may also include enabling a UE to transition from UL communications involving a main TRP to UL communications involving the UL-only TRP. Information and instructions 2255 may enable these and many other features and examples are described herein.

In some implementations, baseband circuitry 2104 can include one or more audio digital signal processor(s) (DSP) 2104F. Audio DSP 2104F can include elements for compression/decompression and echo cancellation and can include other suitable processing elements in other implementations. Components of baseband circuitry 2104 can be suitably combined in a single chip, a single chipset, or disposed on a same circuit board in some implementations. In some implementations, some or all of the constituent components of baseband circuitry 2104 and application circuitry 2102 can be implemented together such as, for example, on a system on a chip (SOC).

In some implementations, baseband circuitry 2104 can provide for communication compatible with one or more radio technologies. For example, in some implementations, baseband circuitry 2104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 2104 is configured to support radio communications of more than one wireless protocol can be referred to as multi-mode baseband circuitry.

RF circuitry 2106 can enable communication with wireless networks using modulated electromagnetic radiation through a non-solid medium. In various implementations, RF circuitry 2106 can include switches, filters, amplifiers, etc., to facilitate the communication with the wireless network. RF circuitry 2106 can include a receive signal path which can include circuitry to down-convert RF signals received from FEM circuitry 2108 and provide baseband signals to baseband circuitry 2104. RF circuitry 2106 can also include a transmit signal path which can include circuitry to up-convert baseband signals provided by baseband circuitry 2104 and provide RF output signals to FEM circuitry 2108 for transmission.

In some implementations, the receive signal path of RF circuitry 2106 can include mixer circuitry 2106A, amplifier circuitry 2106B and filter circuitry 2106C. In some implementations, the transmit signal path of RF circuitry 2106 can include filter circuitry 2106C and mixer circuitry 2106A. RF circuitry 2106 can also include synthesizer circuitry 2106D for synthesizing a frequency for use by mixer circuitry 2106A of the receive signal path and the transmit signal path. In some implementations, mixer circuitry 2106A of the receive signal path can be configured to down-convert RF signals received from FEM circuitry 2108 based on the synthesized frequency provided by synthesizer circuitry 2106D. Amplifier circuitry 2106B can be configured to amplify the down-converted signals and filter circuitry 2106C can be a low-pass filter (LPF) or band-pass filter (BPF) configured to remove unwanted signals from the down-converted signals to generate output baseband signals. Output baseband signals can be provided to baseband circuitry 2104 for further processing. In some implementations, the output baseband signals can be zero-frequency baseband signals, although this may not be a requirement. In some implementations, mixer circuitry 2106A of the receive signal path can comprise passive mixers, although the scope of the implementations is not limited in this respect.

In some implementations, mixer circuitry 2106A of the transmit signal path can be configured to up-convert input baseband signals based on the synthesized frequency provided by synthesizer circuitry 2106D to generate RF output signals for FEM circuitry 2108. The baseband signals can be provided by baseband circuitry 2104 and can be filtered by filter circuitry 2106C. In some implementations, mixer circuitry 2106A of the receive signal path and mixer circuitry 2106A of the transmit signal path can include two or more mixers and can be arranged for quadrature down conversion and up conversion, respectively. In some implementations, mixer circuitry 2106A of the receive signal path and mixer circuitry 2106A of the transmit signal path can include two or more mixers and can be arranged for image rejection. In some implementations, mixer circuitry 2106A of the receive signal path and mixer circuitry 2106A can be arranged for direct down conversion and direct up conversion, respectively. In some implementations, mixer circuitry 2106 of the receive signal path and mixer circuitry 2106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 2106 can include analog-to-digital converter (ADC) and digital-to-analog converter (DAC) circuitry and baseband circuitry 2104 can include a digital baseband interface to communicate with RF circuitry 2106.

In some dual-mode implementations, a separate radio integrated circuitry can be provided for processing signals for each spectrum, although the scope of the implementations is not limited in this respect. In some implementations, synthesizer circuitry 2106D can be a fractional-N synthesizer or a fractional N/N+1 synthesizer, although the scope of the implementations is not limited in this respect as other types of frequency synthesizers can be suitable. For example, synthesizer circuitry 2106D can be a delta-sigma synthesizer, a frequency multiplier, or a synthesizer comprising a phase-locked loop with a frequency divider.

Synthesizer circuitry 2106D can be configured to synthesize an output frequency for use by mixer circuitry 2106A of RF circuitry 2106 based on a frequency input and a divider control input. In some implementations, synthesizer circuitry 2106D can be a fractional N/N+1 synthesizer. In some implementations, frequency input can be provided by a voltage-controlled oscillator (VCO). Divider control input can be provided by either baseband circuitry 2104 or the applications circuitry 2102 depending on the desired output frequency. In some implementations, a divider control input (e.g., N) can be determined from a look-up table based on a channel indicated by the applications circuitry 2102.

Synthesizer circuitry 2106D of RF circuitry 2106 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 2106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 2106 can include an in-phase/quadrature (I/Q)/polar converter.

FEM circuitry 2108 can include a receive signal path which can include circuitry configured to operate on RF signals received from one or more antennas 2110, amplify the received signals and provide the amplified versions of the received signals to RF circuitry 2106 for further processing. FEM circuitry 2108 can also include a transmit signal path which can include circuitry configured to amplify signals for transmission provided by RF circuitry 2106 for transmission by one or more of the one or more antennas 2110. In various implementations, the amplification through the transmit or receive signal paths can be done solely in RF circuitry 2106, solely in FEM circuitry 2108, or in both RF circuitry 2106 and FEM circuitry 2108.

In some implementations, FEM circuitry 2108 can include a transmit/receive switch to switch between transmit mode and receive mode operation. FEM circuitry 2108 can include a receive signal path and a transmit signal path. The receive signal path of FEM circuitry 2108 can include a low noise amplifier to amplify received RF signals and provide the amplified received RF signals as an output (e.g., to RF circuitry 2106). The transmit signal path of FEM circuitry 2108 can include a power amplifier to amplify input RF signals (e.g., provided by RF circuitry 2106), and one or more filters to generate RF signals for subsequent transmission (e.g., by one or more of one or more antennas 2110).

In some implementations, PMC 2112 can manage power provided to baseband circuitry 2104. In particular, PMC 2112 can control power-source selection, voltage scaling, battery charging, or direct current (DC) to DC (DC-to-DC) conversion. PMC 2112 can often be included when device 2100 is capable of being powered by a battery, for example, when device 2100 is included in a UE. PMC 2112 can increase the power conversion efficiency while providing desirable implementation size and heat dissipation characteristics.

While FIG. 21 shows PMC 2112 coupled only with baseband circuitry 2104. However, in other implementations, PMC 2112 can be additionally or alternatively coupled with, and perform similar power management operations for, other components such as, but not limited to, application circuitry 2102, RF circuitry 2106, or FEM circuitry 2108.

In some implementations, PMC 2112 can control, or otherwise be part of, various power saving mechanisms of device 2100. For example, if device 2100 is in an RRC_Connected state, where device 2100 is still connected to the RAN node as device 2100 expects to receive traffic shortly, then device 2100 can enter a state known as discontinuous reception mode (DRX) after a period of inactivity. During this state, device 2100 can power down for brief intervals of time and thus save power.

If there is no data traffic activity for an extended period of time, then device 2100 can transition off to an RRC_Idle state, where device 2100 disconnects from the network and does not perform operations such as channel quality feedback, handover, etc. Device 2100 can go into a very low power state and device 2100 can perform paging where again device 2100 periodically can wake up to listen to the network and then power down again. Device 2100 may not receive data in this state; in order to receive data, device 2100 can transition back to RRC_Connected state.

An additional power saving mode can allow a device to be unavailable to the network for periods longer than a paging interval (ranging from seconds to a few hours). During this time, the device 2100 can be unreachable to the network and can power down completely. Any data sent during this time can incur a large delay and device 2100 can assume the delay is acceptable.

Processors of application circuitry 2102 and processors of baseband circuitry 2104 can be used to execute elements of one or more instances of a protocol stack. For example, processors of baseband circuitry 2104, alone or in combination, can be used execute Layer 3, Layer 2, or Layer 1 functionality, while processors of baseband circuitry 2104 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

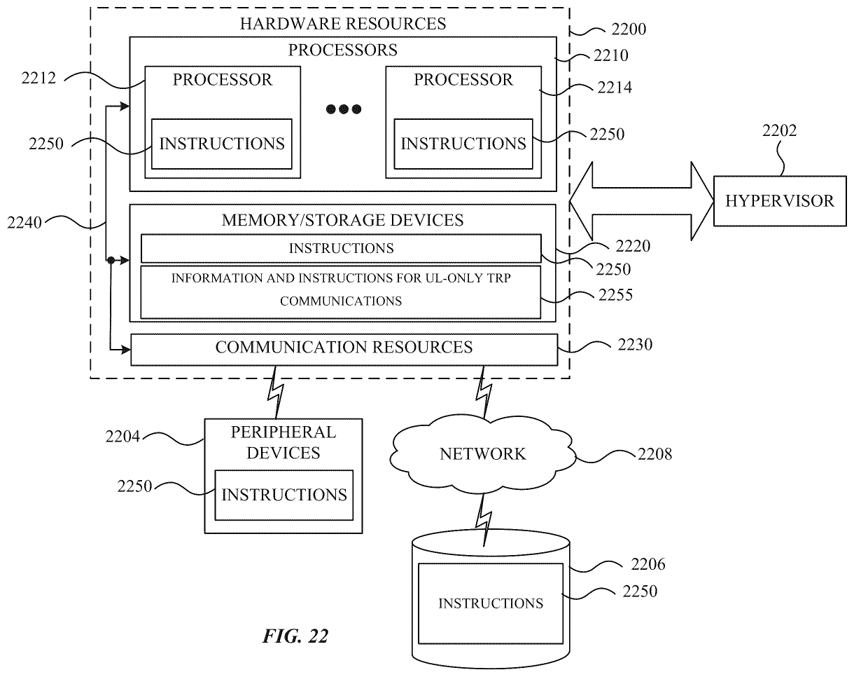

FIG. 22 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 22 shows a diagrammatic representation of hardware resources 2200 including one or more processors 2210 (or processor cores), one or more memory/storage devices 2220, and one or more communication resources 2230, each of which can be communicatively coupled via a bus 2240. For implementations where node virtualization or network function virtualization is utilized, a hypervisor can be executed to provide an execution environment for one or more network slices/sub-slices to utilize hardware resources 2200. Hardware resources 2200 can interact with hypervisor 2202. For example, hypervisor 2202 can schedule or otherwise manage hardware resource 2200.

Processors 2210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 2212 and a processor 2214.

In some implementations, memory/storage devices 2220 receive and/or store information and instructions 2255 for enabling UE 210 to communicate with a UL-only TRP as described herein. The UL-only TRP may include a first base station 222 operating as an SCell, and a second base station 222 operating as a main TRP or PCell. Information and instructions 2255 may also enable determining a TA for UL communications, controlling UL transmission power, and managing beams for UL communications between a UE and the UL-only TRP. Information and instructions 2255 may also include enabling a UE to transition from UL communications involving a main TRP to UL communications involving the UL-only TRP. Information and instructions 2255 may enable these and many other features and examples are described herein.

Communication resources 2230 can include interconnection or network interface components or other suitable devices to communicate with one or more peripheral devices 2204 or one or more databases 2206 via a network 2208. For example, communication resources 2230 can include wired communication components (e.g., for coupling via a universal serial bus), cellular communication components, near field communication components, Bluetooth® components (e.g., Bluetooth® Low Energy), Wi-Fi® components, and other communication components.

Instructions 2250A, 2250B, 2250C, 2250D, and/or 2250E can comprise software, a program, an application, an applet, an app, or other executable code for causing at least any of processors 2210 to perform any one or more of the methodologies discussed herein. Instructions 2250 can reside, completely or partially, within at least one of processors 2210 (e.g., within a cache memory), memory/storage devices 2220, or any suitable combination thereof. Furthermore, any portion of instructions 2250A-E can be transferred to hardware resources 2200 from any combination of peripheral devices 2204 or databases 2206. Accordingly, memory of processors 2210, memory/storage devices 2220, peripheral devices 2204, and databases 2206 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise a memory; and one or more processors configured to, when executing instructions stored in the memory, cause the UE to: receive, from a base station operating as a main transmission and reception point (TRP), configuration information for a random access (RA) procedure toward a base station operating as an uplink (UL) only TRP; perform RA procedure toward the UL-only TRP; and communicate with the main TRP by: receiving downlink (DL) communications from the main TRP; and transmitting UL communications to the UL-only TRP.

In example 2, which may also include one or more of the examples described herein, the configuration information comprises a system information block type 1 (SIB1) that includes a RxOnlyTrpConfigCommom information element (IE) for UL communication to the UL-only TRP. In example 3, which may also include one or more of the examples described herein, the configuration information comprises a system information block type 1 (SIB1) that includes a reference signal received power (RSRP) threshold; and the UE is configured to determine to perform the RA procedure based on a comparison of a measured RSRP and the RSRP threshold.

In example 4, which may also include one or more of the examples described herein, the configuration information comprises: at least one system information block (SIB) that is associated with at least one radio access channel (RACH) occasion (RO) and at least one RA preamble for UL communications toward the main TRP; and at least one SIB that is associated with at least one other RO and at least one other RA preamble for UL communications toward the UL-only TRP. In example 5, which may also include one or more of the examples described herein, the UE is configured to send multiple MSG 3 transmission with a UL beam over different ROs associated with the at least one SIB for UL communications toward the UL-only TRP.

In example 6, which may also include one or more of the examples described herein, the UE is configured to perform beam sweeping and refinement to perform the RA procedure toward the UL-only TRP. In example 7, which may also include one or more of the examples described herein, the configuration information comprises: a RACH configuration index associated with the UL-only TRP; a target transmission power for communicating a RA preamble to the UL-only TRP; and a maximum transmission power for communicating the RA preamble to the UL-only TRP. In example 8, which may also include one or more of the examples described herein, the RA procedure may be a contention-based RA (CBRA) procedure or a contention free RA procedure (CFRA) procedure.

In example 9, which may also include one or more of the examples described herein, the configuration information comprises at least one RA preamble associated with the UL-only TRP. In example 10, which may also include one or more of the examples described herein, the configuration information comprises at least one reserved bit in downlink control information (DCI) indicating a RA procedure toward the UL-only TRP. In example 11, which may also include one or more of the examples described herein, the UE is configured to: initiate the RA procedure toward the UL-only TRP in response to determining that a measured RSRP, corresponding to a downlink (DL) beam from the main TRP, is below an RSRP threshold.

In example 12, which may also include one or more of the examples described herein, the UE is configured to: initiate an RA procedure toward the main TRP in response to determining that a measured RSRP, corresponding to a downlink (DL) beam from the main TRP, is above an RSRP threshold. In example 13, which may also include one or more of the examples described herein, the UE is configured to: receive an effective timing advance (TA) from the UL-only TRP, wherein the effective TA is based on subtracting a propagation delay between the UL-only TRP and the main TRP from a calculated TA at the UL-only TRP; and apply the effective TA to UL communications toward the UL-only TRP. In example 14, which may also include one or more of the examples described herein, the UE is configured to: determine a transmission power for UL transmissions toward the UL-only TRB based on a measure RSRP being below a threshold RSRP.

In example 15, which may also include one or more of the examples described herein, the UE is configured to: determine a transmission power for UL transmissions toward the UL-only TRB based on DCI received from the main TRP. In example 16, which may also include one or more of the examples described herein, the UE is configured to: determine a transmission power for MSG 3 transmissions based on a power offset for UL transmissions toward the UL-only TRB, the power off set for UL transmissions toward the UL-only TRB being different than a power off set for UL transmissions toward the main TRB. In example 17, which may also include one or more of the examples described herein, the UE is configured to: determine a transmission power for a MSG 3 transmissions based on a power transmission modifier received from the main TRP in an RRC connected mode.

In example 18, which may also include one or more of the examples described herein, the UE is configured to: receive, from the main TRP, a path loss (PL) for UL communications toward the UL-only TRP. In example 19, which may also include one or more of the examples described herein, the UE is configured to: determine a transmission power for a sounding reference signal (SRS) toward the UL-only TRP based on a referenceSignalPowerSrs IE received via DCI. In example 20, which may also include one or more of the examples described herein, the UE is configured to: determine a transmission power for a sounding reference signal (SRS) toward the UL-only TRP based on a (Po, α) set that is different than a (Po, α) set associated with the main TRP.

In example 21, which may also include one or more of the examples described herein, a base station, comprising: a memory; and one or more processors configured to, when executing instructions stored in the memory, cause the base station to: send, a user equipment (UE) configuration information for a random access (RA) procedure toward an uplink (UL) only TRP; receive, from the UL-only TRP, uplink (UL) communications originating from the UE; and send downlink (DL) communications directly to the UE. In example 22, which may also include one or more of the examples described herein, the configuration information comprises at least on of: a RxOnlyTrpConfigCommom information element (IE) associated with the UL-only TRP; at least one radio access channel (RACH) occasion (RO) associated with the UL-only TRP; at least one RA preamble associated with the UL-only TRP; or a reference signal received power (RSRP) threshold.

In example 23, which may also include one or more of the examples described herein, the configuration information comprises at least on of: a prach-ConfigurationIndex IE associated with the UL-only TRP; a preambleReceivedTargetPower IE associated with the UL-only TRP; or a preambleTransMax IE associated with the UL-only TRP. In example 24, which may also include one or more of the examples described herein, the configuration information comprises at least on of: DCI comprising a RACH preamble index associated with the UL-only TRP; or a reference signal received power (RSRP) threshold. In example 25, which may also include one or more of the examples described herein, the base station is configured to: receive, from the UL-only TRP, path loss (PL) information associated with a UL signal between the UE and the UL-only TRP; and communicate the PL information to the UE.

In example 26, which may also include one or more of the examples described herein, the configuration information comprises at least one of: information for transmission power control for PRACH communications toward the UL-only TRP; or information for transmission power control for SRS communications toward the UL-only TRP. In example 27, which may also include one or more of the examples described herein, a method, performed by a user equipment (UE), according to one or more of the examples described herein. In example 28, which may also include one or more of the examples described herein, a baseband processor, comprising: a memory; and one or more processors configured to, when executing instructions stored in the memory, cause the baseband processor to perform according to one or more of the examples described herein.

In example 29, which may also include one or more of the examples described herein, a base station, comprising: a memory; and one or more processors configured to, when executing instructions stored in the memory, cause the base station to: perform a random access (RA) channel procedure regarding a user equipment (UE); and operate as an uplink (UL) only transmission and reception point (TRP) for the user equipment (UE) and a main TRP by: receiving UL communications from the UE; and sending the UL communications to the main TRP. In example 30, which may also include one or more of the examples described herein, the base station is configured to: determine a timing advance (TA) for the UE; and communicate the TA to the UE.

In example 31, which may also include one or more of the examples described herein, the base station is configured to: determine a path loss (PL) for UL communications from the UE; and communicate the PL to the main TRP. In example 32, which may also include one or more of the examples described herein, a method, performed by a base station, according to one or more of the examples described herein. In example 33, which may also include one or more of the examples described herein, a computer-readable medium, storing instruction configured to cause one or more processors to perform according to one or more of the examples described herein.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

A system may include, but is not limited to, one or more components, devices, and/or networks capable of communicating or otherwise interacting with one another. For example, a system may include a processor communicatively coupled to a memory device storing one or more machine-readable instructions. A system may also, or alternatively, include a computing device (e.g., a mobile device, a computer, etc.) capable of communicating, or otherwise interacting, with another computing device and/or network device (e.g., a router, base station, repeater, network hub, etc.). A system may also, or alternatively, include network components capable of communicating, or otherwise interacting, with one another. A device may include, but is not limited to, a physical object comprising one or more components configured to communicate or otherwise interact with one another. For example, a device may include a processor coupled to a memory device, an antenna, and/or one or more other types of components via a communication interface. A method may include, but is not limited to, one or more operations, functions, processes, and/or other types of state-changing actions, which may be performed by one or more systems, devices, and/or components, or any combination thereof.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
receive, from a main transmission and reception point (TRP), configuration information for a random access (RA) procedure toward an uplink (UL) only (UL-only) TRP;
perform the RA procedure toward the UL-only TRP; and
communicate with the main TRP by:
receiving downlink (DL) communications from the main TRP; and
transmitting UL communications to the UL-only TRP.

2. The UE of claim 1, wherein the configuration information comprises a system information block type 1 (SIB1) that includes a RxOnlyTrpConfigCommom information element (IE) for UL communication to the UL-only TRP.

3. The UE of claim 1, wherein:
the configuration information comprises a system information block type 1 (SIB1) that includes a reference signal received power (RSRP) threshold; and
the UE is configured to determine to perform the RA procedure based on a comparison of a measured RSRP and the RSRP threshold.

4. The UE of claim 1, wherein the configuration information comprises:
at least one system information block (SIB) that is associated with at least one radio access channel (RACH) occasion (RO) and at least one RA preamble for UL communications toward the main TRP; and
at least one SIB that is associated with at least one other RO and at least one other RA preamble for UL communications toward the UL-only TRP.

5. The UE of claim 1, wherein the UE is configured to send multiple MSG 3 transmission with a UL beam over different ROs associated with the at least one SIB for UL communications toward the UL-only TRP.

6. The UE of claim 1, wherein the UE is configured to perform beam sweeping and refinement to perform the RA procedure toward the UL-only TRP.

7. The UE of claim 1, wherein the configuration information comprises:
a RACH configuration index associated with the UL-only TRP;
a target transmission power for communicating a RA preamble to the UL-only TRP; and
a maximum transmission power for communicating the RA preamble to the UL-only TRP.

8. The UE of claim 1, wherein the RA procedure may be a contention-based RA (CBRA) procedure or a contention free RA procedure (CFRA) procedure.

9. The UE of claim 1, wherein the configuration information comprises at least one RA preamble associated with the UL-only TRP.

10. The UE of claim 1, wherein the configuration information comprises at least one reserved bit in downlink control information (DCI) indicating a RA procedure toward the UL-only TRP.

11. The UE of claim 1, wherein the UE is configured to:
initiate the RA procedure toward the UL-only TRP in response to determining that a measured RSRP, corresponding to a downlink (DL) beam from the main TRP, is below an RSRP threshold.

12. The UE of claim 11, wherein the UE is configured to:
initiate an RA procedure toward the main TRP in response to determining that a measured RSRP, corresponding to a downlink (DL) beam from the main TRP, is above an RSRP threshold.

13. The UE of claim 1, wherein the UE is configured to:
receive an effective timing advance (TA) from the UL-only TRP, wherein the effective TA is based on subtracting a propagation delay between the UL-only TRP and the main TRP from a calculated TA at the UL-only TRP; and
apply the effective TA to UL communications toward the UL-only TRP.

14. The UE of claim 1, wherein the UE is configured to:
determine a transmission power for UL transmissions toward the UL-only TRB based on a measure RSRP being below a threshold RSRP.

15. The UE of claim 1, wherein the UE is configured to:
determine a transmission power for UL transmissions toward the UL-only TRB based on DCI received from the main TRP.

16. The UE of claim 1, wherein the UE is configured to:
determine a transmission power for MSG 3 transmissions based on a power offset for UL transmissions toward the UL-only TRB, the power off set for UL transmissions toward the UL-only TRB being different than a power off set for UL transmissions toward the main TRB.

17. The UE of claim 1, wherein the UE is configured to:
determine a transmission power for a MSG 3 transmissions based on a power transmission modifier received from the main TRP in an RRC connected mode.

18. The UE of claim 1, wherein the UE is configured to:
receive, from the main TRP, a path loss (PL) for UL communications toward the UL-only TRP.

19. A base station, comprising:
a memory; and
one or more processors configured to, when executing instructions stored in the memory, cause the base station to:
send a user equipment (UE) configuration information for a random access (RA) procedure toward an uplink (UL) only TRP;
receive, from the UL-only TRP, uplink (UL) communications originating from the UE; and
send downlink (DL) communications directly to the UE.

20. A base station, comprising:
a memory; and
one or more processors configured to, when executing instructions stored in the memory, cause the base station to:
receive, from a user equipment (UE), uplink (UL) transmissions associated with a random access (RA) channel procedure between the UE and a main transmission and reception point (TRP); and
communicate, to the main TRP, the UL transmissions,
wherein downlink (DL) transmissions associated with the RA channel procedure are communicated directly from the main TRP and the UE.
